(19) United States
(12) Patent Application Publication
(10) Pub. No.: US 2023/0282844 A1
(43) Pub. Date: Sep. 7, 2023

(54) Annular Packing Material, Electrochemical Module, Electrochemical Device, Energy System, Solid Oxide Fuel Cell, and Solid Oxide Electrolysis Cell

(71) Applicant: Osaka Gas Co., Ltd., Osaka-shi (JP)

(72) Inventors: Norihisa Shinke, Osaka-shi (JP); Mitsuaki Echigo, Osaka-shi (JP); Kyohei Manabe, Osaka-shi (JP); Hisao Ohnishi, Osaka-shi (JP); Masakazu Yoda, Osaka-shi (JP); Tadayuki Sogi, Osaka-shi (JP); Akio Inaya, Osaka-shi (JP)

(21) Appl. No.: 17/916,120

(22) PCT Filed: Mar. 31, 2021
(86) PCT No.: PCT/JP2021/013832

§ 371 Date: Apr. 6, 2023

(30) Foreign Application Priority Data
Mar. 31, 2020 (JP) 2020-064527

(51) Int. Cl. H01M 8/0282; F16J 15/08; H01M 8/0276; C25B 9/60; C25B 9/70

(52) U.S. Cl. CPC H01M 8/0282; C25B 9/60; C25B 9/70; F16J 15/08; H01M 8/0276; H01M 2008/1293

(57) ABSTRACT

The present invention includes metal materials 42a and 52a made of thermally expandable members that thermally expand, and insulating metal oxide layers 42b and 52b. The metal materials 42a and 52a and the metal oxide layers 42b and 52b formed in an annular shape have through holes 42c and 52c thereinside.

### CROSS-REFERENCE TO RELATED APPLICATIONS

This application is the U.S. national phase of International Application No. PCT/JP2021/013832 filed Mar. 31, 2021, and claims priority to Japanese Patent Application No. 2020-064527 filed Mar. 31, 2020, the disclosures of which are hereby incorporated by reference in their entireties.

### BACKGROUND OF THE INVENTION

### Field of the Invention

The present invention relates to an annular packing material capable of being used in, for example, an electrochemical module, an electrochemical module that includes the annular packing material, an electrochemical device, an energy system, a solid oxide fuel cell, and a solid oxide electrolysis cell.

### Description of Related Art

A fuel-cell cell stack is configured as a stack obtained by stacking a plurality of electrochemical element (power generating cells). A sealing material for maintaining an ability to seal in reaction gas is provided between the power generating cells.

For example, as described in JP 2016-511506A (Patent Document 1), some conventionally known sealing materials contain an insulating material such as vermiculite for the purpose of preventing a short circuit by blocking electronic conduction between the power generating cells.

### Patent Documents

Patent Document 1: JP 2016-511506A

### SUMMARY OF THE INVENTION

In general, the temperature of the fuel-cell cell stack rises to a high temperature of 500° C. or higher during power generation, and therefore, excellent thermal resistance is required for the sealing material.

Although inorganic materials such as vermiculite have excellent thermal resistance, they are likely to harden when being exposed to high temperatures. Accordingly, when the fuel-cell cell stack is repeatedly started and stopped, and thus its temperature changes, the sealing material constituted by vermiculite and the like hardens at high temperatures, and thus the contact pressure decreases due to a decrease in elasticity. As a result, the sealing ability of the sealing material decreases, and thus a reaction gas is likely to leak.

It is an object of the present invention to provide an annular packing material that maintains high sealing properties and insulating properties even when being exposed to temperature changes including a high-temperature environment, an electrochemical module that includes the annular packing material, an electrochemical device that includes the electrochemical module, an energy system that includes the electrochemical device, a solid oxide fuel cell that includes the electrochemical module, and a solid oxide electrolysis cell that includes the electrochemical module.

In a characteristic configuration for achieving the above-mentioned object, an annular packing material according to the present invention includes a metal material made of a thermally expandable member that thermally expands; and an insulating metal oxide layer, wherein the metal material and the metal oxide layer formed in an annular shape have a through hole thereinside.

With the characteristic configuration above, when the annular packing material is exposed to high temperatures, the contact pressure increases due to the expansion tension of the metal material, and thus a high ability to seal between the inside and the outside with respect to the metal material and the metal oxide layer (between the inside and the outside of the ring) is exhibited. The metal material is not likely to harden even when being exposed to high temperatures, and therefore, the annular packing material can be used for a long period of time while being exposed to temperature changes including a high-temperature environment. Furthermore, the insulating properties are maintained due to the metal oxide layer.

In another characteristic configuration of the annular packing material according to the present invention, the metal oxide layer is arranged on at least one side in a thickness direction of the metal material.

With the characteristic configuration above, the insulating properties can be maintained due to the metal oxide layer.

In another characteristic configuration of the annular packing material according to the present invention, the metal oxide layer includes one or more of alumina, silica, magnesium oxide, iron oxide, chromium oxide, and manganese oxide.

With the characteristic configuration above, the metal oxide layer can be made of easily available raw materials.

In another characteristic configuration of the annular packing material according to the present invention, the metal material includes one or more of ferrite-based stainless steel, austenite-based stainless steel, Inconel, copper, and an invar material.

With the characteristic configuration above, the metal material can be made of easily available raw materials.

In another characteristic configuration of the annular packing material according to the present invention, the metal material has a cross-sectional shape that is a ring shape provided with a closed space thereinside.

With the characteristic configuration above, when the annular packing material is exposed to a high-temperature environment, expansion of the metal material is further promoted due to thermal expansion of the gas or liquid filling the closed space (inner space) formed inside the annular shape, and accordingly, the contact pressure can be increased. As a result, much higher sealing ability is exhibited.

In another characteristic configuration of the annular packing material according to the present invention, the metal material is made of a bimetal.

With the characteristic configuration above, the annular packing material changes its shape into a specific shape in response to the temperature change. Therefore, when being exposed to a high-temperature environment, the annular packing material changes its shape, and accordingly, the contact pressure can be increased. As a result, much higher sealing ability is exhibited.

In another characteristic configuration of the annular packing material according to the present invention, the metal material has a cross-sectional shape that includes one or more of a flat-plate shape, a triangular shape, a saw-blade shape, a wavelike shape, a circular shape, an elliptic shape, a substantially C-shape, and a substantially D-shape.

With the characteristic configuration above, various shapes can be employed as the shape of the metal material, and thus the annular packing material can be used for various purposes.

In a characteristic configuration for achieving the above-mentioned object, an electrochemical module according to the present invention includes a plurality of electrochemical elements that each include: an electrolyte layer; and a first electrode and a second electrode that are respectively arranged on two sides of the electrolyte layer, the electrochemical elements being stacked with metal substrates provided therebetween, wherein the annular packing material is arranged between adjacent metal substrates.

With the characteristic configuration above, even in an environment in which the temperature varies and may rise to high temperatures, the electrochemical module can be used for a long period of time because the metal material is not likely to harden even at high temperatures. Furthermore, when the electrochemical module is exposed to a high-temperature environment, the contact pressure is increased due to expansive force of the metal material. Thus, high sealing ability is exhibited, and therefore, sealing between the adjacent metal substrates is sufficiently ensured. Moreover, the metal oxide layer is formed, and thus insulation between the adjacent metal substrates is also achieved.

In another characteristic configuration of the electrochemical module according to the present invention, the metal material has a thermal expansion coefficient that is different from a thermal expansion coefficient of the metal substrate.

With the characteristic configuration above, when the electrochemical module is exposed to a high-temperature environment, thermal expansive force caused by a difference in thermal expansion between the metal substrate and the metal material can be utilized to increase the contact pressure. As a result, much higher sealing ability is exhibited.

In another characteristic configuration of the electrochemical module according to the present invention, a ceramic paste is applied to at least a part of a surface of the annular packing material, the ceramic paste being arranged between the metal substrate and the annular packing material.

With the characteristic configuration above, the ceramic paste fills a minute gap between the annular packing material and the metal substrate. As a result, much higher sealing ability is exhibited.

In another characteristic configuration of the electrochemical module according to the present invention, the ceramic paste contains mica.

With the characteristic configuration above, the ceramic paste contains mica. Our experiment has shown that high sealing properties are achieved due to this configuration.

In a characteristic configuration for achieving the above-mentioned object, an electrochemical device according to the present invention includes: the electrochemical module as mentioned above; and a fuel converter that generates a reducing component to be supplied to the electrochemical module or converts gas containing a reducing component generated in the electrochemical module.

With the characteristic configuration above, in the case of operating the electrochemical module as a fuel cell, the fuel converter such as a reformer can be used to generate hydrogen from natural gas or the like supplied using an existing raw fuel supply infrastructure such as city gas, and an electrochemical device that includes an electrochemical module with excellent durability, reliability, and performance can be realized. Also, it is easier to construct a system that recycles unused fuel gas flowing from the electrochemical module, thus making it possible to realize a highly efficient electrochemical device.

On the other hand, when the electrochemical module is operated as an electrolysis cell, gas containing water vapor and carbon dioxide flows to the electrode layer, and a voltage is applied between the electrode layer and the counter electrode layer. As a result, in the electrode layer, electrons e⁻ react with water molecules H₂O and carbon dioxide molecules CO₂ to produce hydrogen molecules H₂, and carbon monoxide CO and oxygen ions O²⁻. The generated oxygen ions O²⁻ move to the counter electrode layer through the electrolyte layer. Then, in the counter electrode layer, the oxygen ions O²⁻ release electrons and oxygen molecules O₂ are produced. Through the reactions above, in the case where gas containing water vapor flows, water molecules H₂O are decomposed into hydrogen H₂ and oxygen O₂, and in the case where gas containing carbon dioxide molecules CO₂ flows, the carbon dioxide molecules CO₂ are electrolyzed into carbon monoxide CO and oxygen O₂.

Accordingly, in the case where gas containing water vapor and carbon dioxide molecules CO₂ flows, a fuel converter that synthesizes various compounds such as hydrocarbons from hydrogen, carbon monoxide, and the like generated through the above-mentioned electrolysis in the electrochemical module can be provided. This enables hydrocarbons and the like generated by the fuel converter to flow into the electrochemical module, or enables the hydrocarbons and the like to be extracted from the system and the device and separately used as fuel or a chemical raw material.

In another characteristic configuration for achieving the above-mentioned object, an electrochemical device according to the present invention includes: the electrochemical module as mentioned above; and a power converter that extracts power from the electrochemical module, or supplies power to the electrochemical module.

With the characteristic configuration above, the power converter extracts power generated by the electrochemical module or supplies power to the electrochemical module. Thus, as mentioned above, the electrochemical module serves as a fuel cell or an electrolysis cell. Accordingly, with the configuration above, it is possible to provide an electrochemical device that can improve the efficiency of converting chemical energy such as fuel into electric energy or can improve the efficiency of converting electric energy into chemical energy such as fuel.

Note that it is preferable to use an inverter as the power converter, for example, because the inverter can be used to boost electrical output obtained from the electrochemical module with excellent durability, reliability, and performance, and to convert a direct current into an alternating current, thus making it easy to use the electrical output obtained from the electrochemical module. Also, in the case where electrolysis is performed, an electrochemical device capable of obtaining a direct current from an AC power source and supplying DC power to the electrochemical element or electrochemical module can be constructed, which is preferable.

In a characteristic configuration for achieving the above-mentioned object, an energy system according to the present invention includes: the electrochemical device as mentioned above; and a waste heat utilization system that reuses heat discharged from the electrochemical device.

With the characteristic configuration above, the electrochemical device and the waste heat utilization system that reuses heat discharged from the electrochemical device are provided, thus making it possible to realize an energy system that has excellent durability, reliability, and performance as well as excellent energy efficiency. Note that it is also possible to realize a hybrid system that has excellent energy efficiency by combination with a power generation system that generates power with use of combustion heat from unused fuel gas discharged from the electrochemical device.

In a characteristic configuration for achieving the above-mentioned object, a solid oxide fuel cell according to the present invention includes the electrochemical module as mentioned above, wherein the electrochemical module causes a power generating reaction.

With the characteristic configuration above, the solid oxide fuel cell that includes the electrochemical module with excellent durability, reliability, and performance can cause a power generating reaction, and thus a solid oxide fuel cell having high durability and high performance can be obtained. Note that a solid oxide fuel cell that can be operated in a temperature range of 650° C. or higher during the rated operation is more preferable because a fuel cell system that uses hydrocarbon-based gas such as city gas as raw fuel can be constructed such that waste heat discharged from a fuel cell can be used as heat required to convert raw fuel to hydrogen, and power generation efficiency of the fuel cell system can thus be improved. A solid oxide fuel cell that is operated in a temperature range of 900° C. or lower during the rated operation is more preferable because the effect of suppressing volatilization of Cr from a metal-supported electrochemical element can be improved, and a solid oxide fuel cell that is operated in a temperature range of 850° C. or lower during the rated operation is even more preferable because the effect of suppressing volatilization of Cr can be further improved.

In a characteristic configuration for achieving the above-mentioned object, a solid oxide electrolysis cell according to the present invention includes the electrochemical module as mentioned above, wherein the electrochemical module causes an electrolysis reaction.

With the characteristic configuration above, the solid oxide electrolysis cell that includes the electrochemical element with excellent durability, reliability, and performance can generate gas through an electrolysis reaction, and thus a solid oxide electrolysis cell having high durability and high performance can be obtained.

### BRIEF DESCRIPTION OF THE DRAWINGS

FIG. 1 is a cross-sectional view of an electrochemical module.

FIG. 2 is a top view of the electrochemical module.

FIG. 3 is a side view of the electrochemical module.

FIG. 4 is a schematic view of the electrochemical module.

FIG. 5 is a cross-sectional view of an electrochemical module according to another aspect 1.

FIG. 6 is a cross-sectional view of an electrochemical module according to another aspect 2.

FIG. 7 is a top view of the electrochemical module shown in FIG. 6.

FIG. 8 is a side view of the electrochemical module shown in FIG. 6.

FIG. 9 is a schematic view of an electrochemical element.

FIG. 10 is a cross-sectional view taken along line X-X in FIG. 9.

FIG. 11 is a cross-sectional view taken along line XI-XI in FIG. 9.

FIG. 12 is a cross-sectional view taken along line XII-XII in FIG. 9.

FIG. 13 is a cross-sectional view taken along line XIII-XIII in FIG. 9.

FIG. 14 is a cross-sectional view taken along line XIV-XIV in FIG. 9.

FIG. 15 is a cross-sectional view taken along line XV-XV in FIG. 9.

FIG. 16 is a cross-sectional view taken along line XVI-XVI in FIG. 9.

FIG. 17 is a cross-sectional view taken along line XVII-XVII in FIG. 9.

FIG. 18 is an enlarged view of a relevant portion of an electrochemical reaction portion.

FIG. 19 is a top view of an annular packing material.

FIG. 20 is a longitudinal cross-sectional view of the annular packing material.

FIG. 21 is a longitudinal cross-sectional view of an annular packing material of another aspect.

FIG. 22 is a longitudinal cross-sectional view of the annular packing material of another aspect after heating.

FIG. 23 is a longitudinal cross-sectional view of an annular packing material of another aspect.

FIG. 24 is a longitudinal cross-sectional view of an annular packing material of another aspect.

FIG. 25 is a longitudinal cross-sectional view of an annular packing material of another aspect.

FIG. 26 is a longitudinal cross-sectional view of an annular packing material of another aspect.

FIG. 27 is a longitudinal cross-sectional view of an annular packing material of another aspect.

FIG. 28 is a longitudinal cross-sectional view of an annular packing material of another aspect.

FIG. 29 is a schematic view of an energy system.

FIG. 30 is an explanatory diagram of an electrochemical module according to another aspect.

FIG. 31 is a schematic view of another energy system.

FIG. 32 is a longitudinal cross-sectional view of an annular packing material of a modified example.

FIG. 33 is a table showing the measurement results of a gas leakage amount.

### DESCRIPTION OF THE INVENTION

### Embodiment

Hereinafter, an electrochemical module M, an electrochemical device, and an energy system according to embodiments of the present invention will be described. Note that, when the positional relationship between layers and the like are described, an electrolyte layer side is referred to as “upper portion” or “upper side”, and a first plate-like body side is referred to as “lower portion” or “lower side”, with respect to an electrode layer, for example. The effect of the present invention in the case where the electrochemical module M is arranged extending in the vertical direction is the same as that in the case where the electrochemical module M is arranged extending in the horizontal direction, and therefore, “upper” and “lower” may be read as “left” and “right”, respectively.

### Overall Configuration of Electrochemical Module M

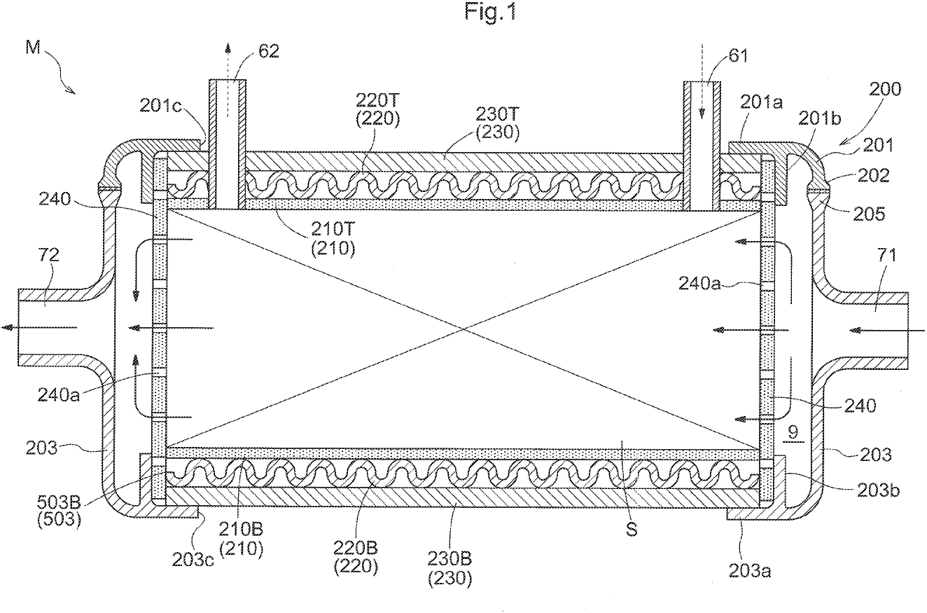

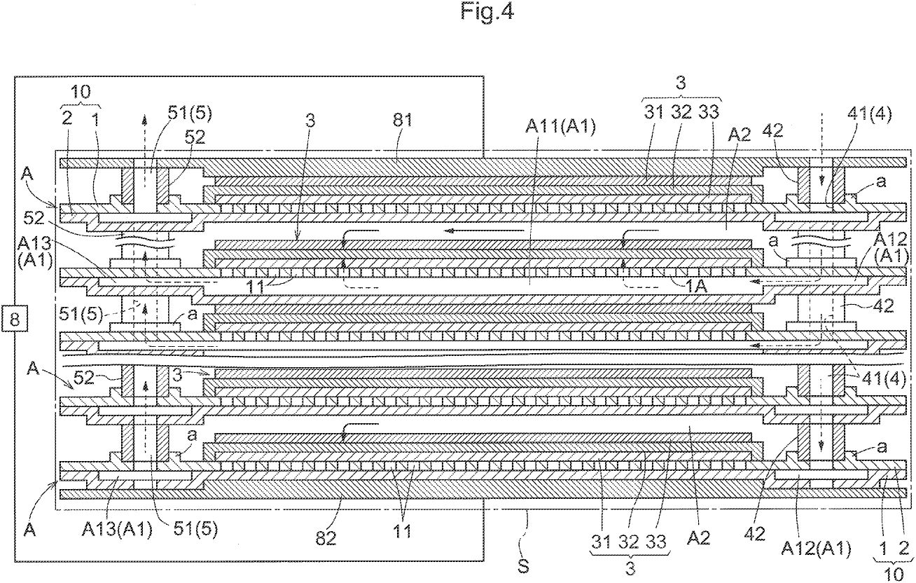

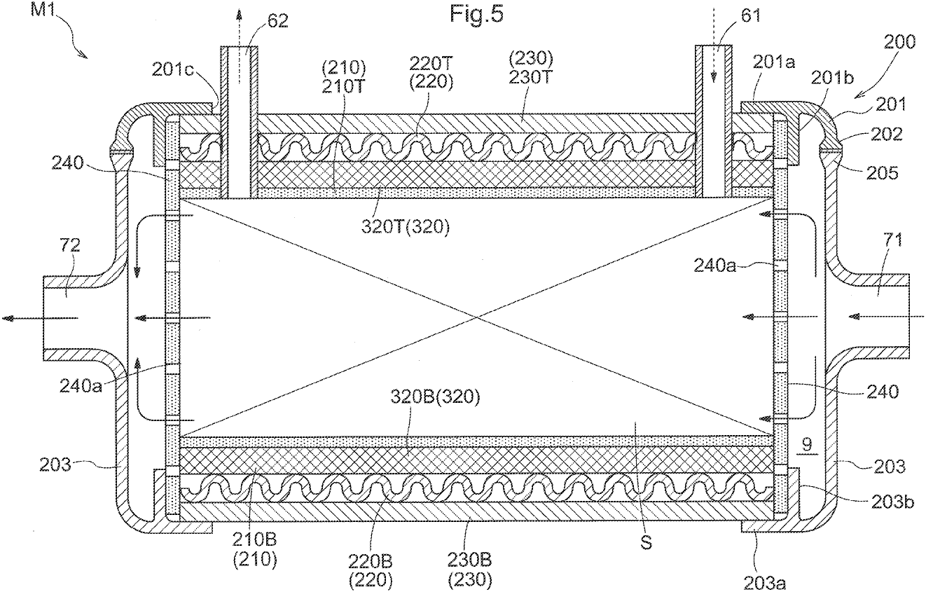

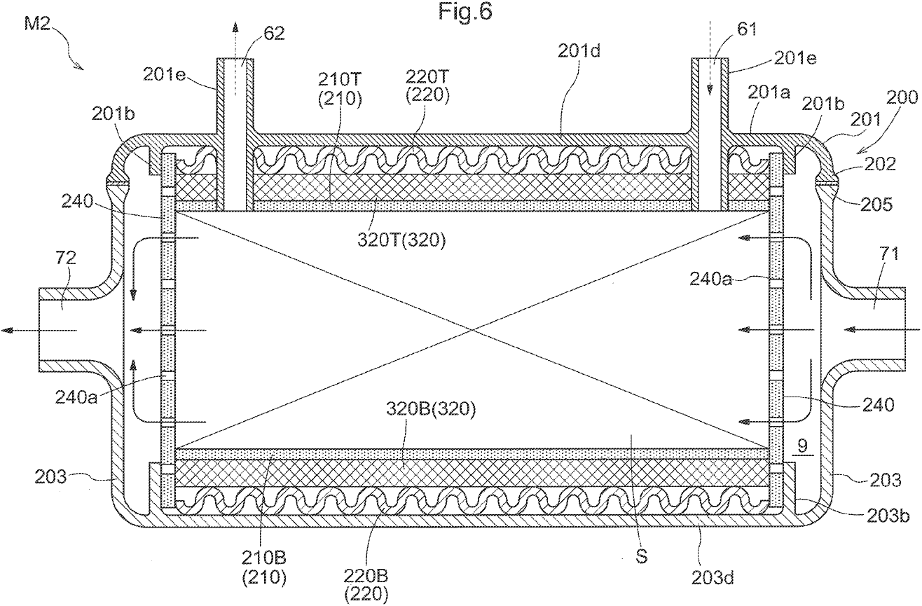

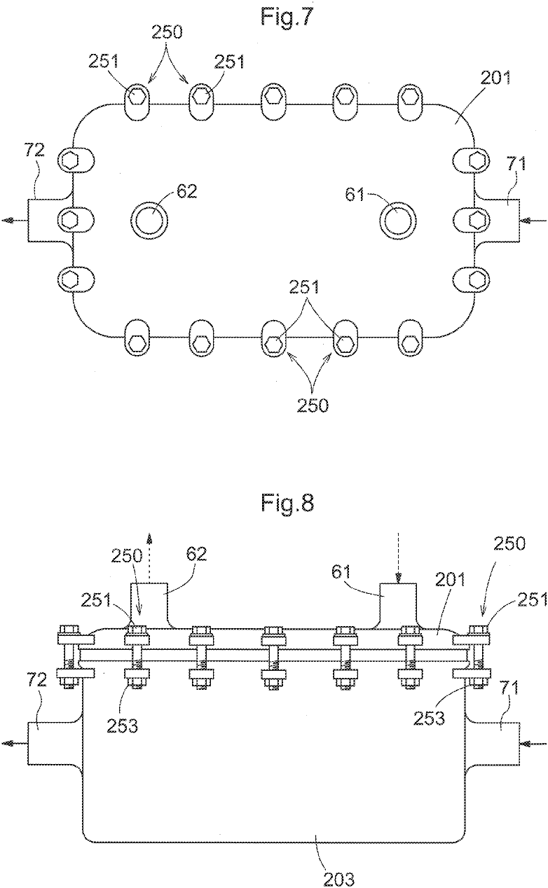

The following is a description of the overall configuration of the electrochemical module M. As shown in FIG. 1, the electrochemical module M includes an electrochemical element stack (stack) S, and a container (body, a first clamping portion, a second clamping portion) 200 that has a substantially rectangular parallelepiped shape and is internally provided with the electrochemical element stack S. An electrochemical element A (FIG. 4) is an element for generating power through a power generating reaction and is formed in a plate shape extending from the front side to the back side in the cross-sectional view shown in FIG. 1. The electrochemical element stack S has a configuration in which a plurality of plate-like electrochemical elements A are stacked in a vertical stacking direction in the cross-sectional view shown in FIG. 1. In the description of this embodiment, an SOFC (Solid Oxide Fuel Cell) is used as an example of the electrochemical element A.

The electrochemical module M also includes a first gas supply portion 61 for supplying first gas to the electrochemical element stack S from the outside of the container 200, and a first gas discharge portion 62 for discharging the first gas used in a reaction in the electrochemical element stack S.

As shown in FIGS. 1 to 3, the container 200 is provided with a second gas supply portion 71 for supplying second gas to the electrochemical element stack S from the outside of the container 200. The second gas used in a reaction in the electrochemical element stack S is discharged from a second gas discharge portion 72 provided in the container 200 to the outside.

Here, for example, the first gas is reducing component gas such as fuel gas, and the second gas is oxidative component gas such as air.

The electrochemical module M includes perforated plate members (non-hard members) 240 on the two side faces of the electrochemical element stack S in the cross-sectional view shown in FIG. 1. The perforated plate members 240 are plate-like members that correspond to the two side faces of the electrochemical element stack S and extend in the direction in which the electrochemical elements A are stacked, and are preferably made of an insulating material such as mica for the purpose of preventing electric short (short circuit) in the electrochemical module M. The perforated plate members 240 are each provided with a plurality of holes 240a that pass through the perforated plate member 240 in the plane direction of the electrochemical element stack S.

Accordingly, the electrochemical element stack S is configured such that fuel gas is supplied from the first gas supply portion 61, air is supplied from the second gas supply portion 71 through the holes 240a of the perforated plate member 240, and power is generated through an electrochemical reaction between the fuel gas and oxygen in the air. The fuel gas used in the electrochemical reaction is discharged from the first gas discharge portion 62 to the outside. The air used in the electrochemical reaction is introduced into the second gas discharge portion 72 through the holes 240a of the perforated plate member 240, and is discharged from the second gas discharge portion 72 to the outside.

Note that, here, the perforated plate members 240 are provided adjacent to the two side faces of the electrochemical element stack S, but this configuration is not essential, and configurations are also possible in which only one of them is provided, or in which both of them are omitted.

Also, the electrochemical module M includes, on the upside of the electrochemical element stack S, an upper insulator 210T, an upper plate-like member 220T, and an upper plate (first clamping portion) 230T, which are arranged in the stated order from the electrochemical element stack S side toward the outside. Similarly, the electrochemical module M includes, on the underside of the electrochemical element stack S, a lower insulator 210B, a lower plate-like member 220B, and a lower plate (second clamping portion) 230B, which are arranged in the stated order from the electrochemical element stack S side toward the outside.

The electrochemical element stack S will be described in detail later.

### Insulator, Plate-Like Member, Plate, and Container

The following is a further description of insulators (upper insulator 210T and lower insulator 210B) 210, plate-like members (upper plate-like member 220T and lower plate-like member 220B) 220, plates (upper plate 230T and lower plate 230B) 230, and a container 200.

The upper insulator 210T is a plate-like member and is arranged so as to cover the top flat face (first flat face) of the electrochemical element stack S. The upper insulator 210T is made of, for example, ceramics or hard mica, and electrically insulates the electrochemical element stack S from the outside.

The upper plate-like member 220T is arranged on the top of the upper insulator 210T. The upper plate-like member 220T is an elastic member, and is formed, for example, in a wavelike shape in the cross-sectional view shown in FIG. 1 in this embodiment. The wavelike shape extends along the flat face of the electrochemical element stack S. Accordingly, the upper plate-like member 220T is arranged such that top portions of the wavelike shape are in contact with the upper insulator 210T.

The thickness of the upper plate-like member 220T having a wavelike shape is, for example, about 0.1 mm to 1 mm, but is not limited thereto. The amplitude (height) of the wavelike shape is, for example, about 1 mm to 10 mm, but is not limited thereto.

The role of the upper plate-like member 220T will be described later.

The upper plate 230T is a plate-like member, is arranged on the top of the upper plate-like member 220T, and is made of a ceramics-based material such as 99 alumina that has a high flexural strength at a high temperature. The upper plate 230T is in contact with at least a portion of the upper plate-like member 220T. In this embodiment, top portions of the wavelike shape of the upper plate-like member 220T are in contact with the upper plate 230T.

The electrochemical element stack S, a pair of the upper insulator 210T and the lower insulator 210B, and a pair of the upper plate-like member 220T and the lower plate-like member 220B are sandwiched between the upper plate 230T and the lower plate 230B with predetermined clamping pressure applied by the container 200. Here, the clamping pressure refers to, for example, pressure per unit area such as 1 mm2.

The lower insulator 210B is arranged so as to cover the bottom flat face (second flat face) of the electrochemical element stack S. The lower plate-like member 220B is arranged on the underside of the lower insulator 210B, and the lower plate 230B is arranged on the underside of the lower plate-like member 220B. The lower insulator 210B, the lower plate-like member 220B, and the lower plate 230B are similar to the upper insulator 210T, the upper plate-like member 220T, and the upper plate 230T, respectively. Note that top portions of the wavelike shape of the lower plate-like member 220B are in contact with the lower plate 230B, and top portions 220Bb thereof are in contact with the lower insulator 210B.

As shown in FIGS. 1 to 3, the container 200 that is internally provided with the electrochemical element stack S has a substantially rectangular parallelepiped shape. The container 200 includes an upper cover (first clamping portion) 201 having a box shape whose bottom portion is open, and a lower cover (second clamping portion) 203 whose top portion is open. A coupling portion 202 is provided on the end face of the upper cover 201 that is opposed to the lower cover 203, and a coupling portion 205 is provided on the end face of the lower cover 203 that is opposed to the upper cover 201. The upper cover 201 and the lower cover 203 are coupled to each other by, for example, welding the coupling portion 202 and the coupling portion 205 to each other, and thus a space having a rectangular parallelepiped shape is formed therein.

In this embodiment, as shown in FIG. 1, the depth of the lower cover 203 in the vertical direction (direction in which the electrochemical elements A are stacked) is larger than the depth of the upper cover 201. However, it is sufficient that the upper cover 201 and the lower cover 203 can form a space therein when integrated, and the relationship between their depths is not limited to the above-mentioned relationship. For example, the depth of the upper cover 201 may be larger than that of the lower cover 203.

As shown in FIGS. 1 to 3, at the center in the vertical direction of the container 200, the second gas supply portion 71 and the second gas discharge portion 72 are respectively formed in the two side walls of the lower cover 203 that are opposed to each other.

Note that, here, the lower cover 203 is provided with the second gas supply portion 71 and the second gas discharge portion 72. However, the positions at which the second gas supply portion 71 and the second gas discharge portion 72 are formed are not limited to the above-mentioned positions, and they may be formed at any positions on the container 200. For example, the upper cover 201 may be provided with the second gas supply portion 71 and the second gas discharge portion 72.

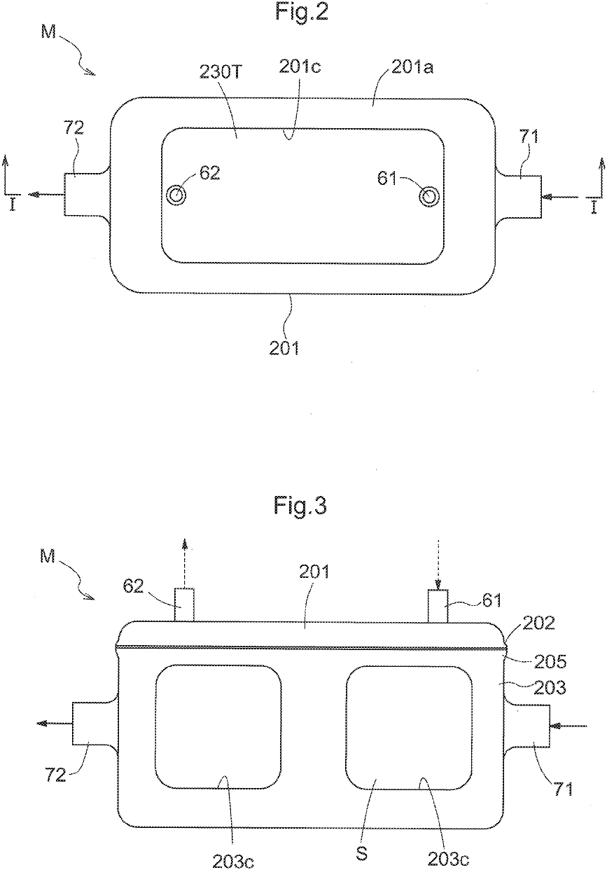

As shown in FIGS. 1 and 2, the upper cover 201 is provided with an opening 201c that is slightly smaller in size than the area surrounded by the outer edge of the upper cover 201. In the cross-sectional view shown in FIG. 1, the end portion on the inner side that is adjacent to the opening 201c and faces the electrochemical element stack S branches into a first end portion 201a and a second end portion 201b. The first end portion 201a extends by a predetermined length toward the inside of the container 200 in the plane direction, and the second end portion 201b branches off from the first end portion 201a and extends by a predetermined length toward the lower portion of the container 200. The first end portion 201a and the second end portion 201b form an angle of substantially 90° in the cross-sectional view and form an L-shaped corner portion. This L-shaped corner portion is formed along the outer edge on the inner side of the outer edge in the top view of the upper cover 201 shown in FIG. 2. Accordingly, as shown in FIGS. 1 and 2, the opening 201c that is slightly smaller in size than the area surrounded by the outer edge of the upper cover 201 as describe above is formed by the end of the first end portion 201a in the top face of the upper cover 201.

In the same manner as in the upper cover 201, the lower cover 203 includes a first end portion 203a and a second end portion 203b that form an angle of substantially 90° and form an L-shaped corner portion in the cross-sectional view shown in FIG. 1. As shown in FIG. 1, an opening 203c that is slightly smaller in size than the area surrounded by the outer edge of the lower cover 203 is formed by the end of the first end portion 203a.

As shown in FIG. 1, the upper ends of the two perforated plate members 240, the upper insulator 210T, the upper plate-like member 220T, and the upper plate 230T are fitted onto the L-shaped corner portion formed by the first end face portion 201a and the second end portion 201b of the upper cover 201. Specifically, the top face of the outer peripheral end portion of the upper plate 230T extending in the plane direction of the electrochemical element stack S is in contact with the bottom face of the first end portion 201a (a portion of the inner face of the L-shaped corner portion) and is supported thereby. The outer face of the upper end portion of each of the perforated plate members 240 extending along the side face of the electrochemical element stack S is in contact with the inner side face of the second end portion 201b (a portion of the inner face of the L-shaped corner portion) and is supported thereby. The upper plate-like member 220T and the upper insulator 210T are supported by the L-shaped corner portion formed by the first end portion 201a and the second end portion 203b, via the upper plate 230T and the perforated plate members 240.

Similarly, the lower ends of the two perforated plate members 240, the lower insulator 210B, the lower plate-like member 220B, and the lower plate 230B are fitted onto a pair of L-shaped corner portions that are opposed to each other in the plane direction of the lower cover 203.

The top face of the electrochemical element stack S is supported by the upper cover 201 via the upper plate 230T, the upper plate-like member 220T, and the upper insulator 210T. The bottom face of the electrochemical element stack S is supported by the lower cover 203 via the lower plate 230B, the lower plate-like member 220B, and the lower insulator 210B.

The upper cover 201 and the lower cover 203 having these configurations are coupled to each other by, for example, welding the coupling portion 202 and the coupling portion 205 to each other in the state in which the electrochemical element stack S, the upper insulator 210T, the lower insulator 210B, the upper plate-like member 220T, the lower plate-like member 220B, the upper plate 230T, the lower plate 230B, and the like are sandwiched between the upper cover 201 and the lower cover 203 from above and below. While the upper cover 201 and the lower cover 203 are coupled to each other, a predetermined load is applied to the electrochemical element stack S and the like. That is, in the state in which the upper cover 201 and the lower cover 203 are coupled to each other, the electrochemical element stack S, the upper insulator 210T, the lower insulator 210B, the upper plate-like member 220T, the lower plate-like member 220B, the upper plate 230T, and the lower plate 230B are clamped by applying a predetermined load thereto.

Note that, as shown in FIG. 3, openings 203e are formed in the side face of the lower cover 203. Accordingly, portions of the side face of the electrochemical element stack S are exposed from the openings 203e. Providing the container 200 with the above-described openings 201c, 203c, and 203e makes it possible to reduce the weight of the container 200 and reduce the amount of the material necessary for the container 200. Note that, when electric short (short circuit) may occur due to contact between the side face of the electrochemical element stack S and one or both of the upper cover 201 and the lower cover 203, a side insulator (not illustrated) made of a material such as mica is provided between the electrochemical element stack S and the side face of the upper cover 201 or lower cover 203.

### Configurations and Functions of Plate-Like Members and Related Members

Next, the configurations and functions of the plate-like members (upper plate-like member 220T and lower plate-like member 220B) 220 and related members will be further described.

As described above, in the state in which the upper cover 201 and the lower cover 203 are coupled to each other, the electrochemical element stack S, the upper insulator 210T, and the lower insulator 210B are clamped between the upper plate 230T and the lower plate 230B while predetermined clamping pressure is applied to the electrochemical element stack S, the upper insulator 210T, and the lower insulator 210B via the upper plate-like member 220T and the lower plate-like member 220B.

### 1) Configurations of Plate-Like Members and Related Members

In this embodiment, the plate-like members 220 are constituted by thermally expandable members that thermally expand. It is preferable that the plate-like members 220 have a thermal expansion rate (thermal expansion coefficient; the same applies hereinafter) larger than the thermal expansion rates of members included in the electrochemical element stack S, the container 200, and the like. An example of the material of such plate-like members 220 is austenite-based stainless steel.

Austenite-based stainless steel has a relatively large thermal expansion rate. For example, aluminum has a thermal expansion rate of about 23.8×10⁻⁶/°C, and austenite-based stainless steel has a thermal expansion rate as large as the thermal expansion rates of aluminum and the like. Regarding the thermal expansion rate of austenite-based stainless steel, SUS303 and SUS304 have a thermal expansion rate of about 17.3×10⁻⁶/°C, and SUS316 has a thermal expansion rate of about 16×10⁻⁶/°C. However, the material of the plate-like members 220 is not limited thereto, and it is preferable to select members that have a thermal expansion rate larger than those of the container 200 and the like and have excellent corrosion resistance.

It is preferable that the container 200 has a thermal expansion rate smaller than the thermal expansion rates of the plate-like members 220. The container 200 is arranged adjacent to the plate-like members 220 via the plates 230.

The lower cover 203 and the upper cover 201 of the container 200 are linked to each other and thus apply clamping pressure to the electrochemical element stack S via the plate-like members 220. Examples of the material of such a container 200 include ferrite-based stainless steel, martensite-based stainless steel, and complexes between ceramics and the above-mentioned stainless steel. These materials have thermal expansion rates smaller than that of austenite-based stainless steel. Regarding the thermal expansion rate of ferrite-based stainless steel, SUS430 has a thermal expansion rate of about 11×10⁻⁶/°C. Regarding the thermal expansion rate of martensite-based stainless steel, SUS403 and SUS420J1 have a thermal expansion rate of about 10.4×10⁻⁶/°C, and SUS410 and SUS440C have a thermal expansion rate of about 10.1×10⁻⁶/°C. However, the container 200 is not limited thereto, and it is preferable to select a material that has a thermal expansion rate smaller than those of the plate-like members 220 and has excellent corrosion resistance.

It is preferable that the material of the electrochemical element stack S is similar to the material of the container 200. In other words, it is preferable that a material of the electrochemical element stack S and the container 200 have thermal expansion rates as large as that of the container 200. In this case, the substrates of the electrochemical element stack S and the container 200 thermally expand to the same degree, for example, at the time of power generation when the electrochemical elements A become hot. Accordingly, it is possible, for example, to reduce a difference in thermal expansion between the substrates of the electrochemical elements A and the container 200 and suppress damage or the like on the substrates.

### 2) Method for Assembling Electrochemical Module M, and Compressional Deformation of Plate-Like Members During Assembly

### (A) Method for Assembling Electrochemical Module M

Next, a method for assembling the above-mentioned electrochemical module M will be described.

The electrochemical element stack S is prepared by stacking a plurality of electrochemical elements A. The configuration of the electrochemical element stack S, and a method for manufacturing the electrochemical element stack S will be described later.

The container 200 for housing the electrochemical element stack S is also prepared. The container 200 can be manufactured using, for example, a lost-wax casting method, but the manufacturing method is not limited thereto. When the lost-wax casting method is used, a hollow model corresponding to the external shape of the container 200 is manufactured using, for example, a thermoplastic substance such as beeswax or pine resin. A fire-resistant material made of silica sand, lime powder, and the like is used to cover this model. Thereafter, the model covered by the fire-resistant material is heated, and thus the model made of the thermoplastic substance is melted and removed. Accordingly, a cavity corresponding to the model having the shape of the container 200 is formed inside the fire-resistant material. The material of the container 200 is injected into this cavity and solidified, and then the fire-resistant substance is removed. Accordingly, the container 200 that includes the upper cover 201 and the lower cover 203 is manufactured using the lost-wax casting method. Note that the upper cover 201 and the lower cover 203 may be separately manufactured.

Next, for example, the two perforated plate members 240 are arranged on the two side faces of the electrochemical element stack S, and the insulator 210, the plate-like member 220, and the plate 230 are arranged one by one on each of the top flat face and the bottom flat face of the electrochemical element stack S, and these members are housed in the lower cover 203 while this state is maintained. The lower cover 203 is covered by the upper cover 201, positional adjustment is performed such that predetermined clamping pressure is applied to the electrochemical element stack S, and then the lower cover 203 and the upper cover 201 are linked to each other through welding or the like. The electrochemical module M is thus assembled.

When the container 200 is manufactured using the lost-wax casting method as mentioned above, the cost can be reduced due to a reduction in thickness, manufacturing accuracy, and mass production.

In this embodiment, forming the box-shaped container 200 makes it possible to provide a space for a manifold for supplying air from the second gas supply portion 71 to the electrochemical element stack S.

### (B) Compressional Deformation of Plate-Like Members During Assembly

During the above-mentioned assembly of the electrochemical module M, predetermined clamping pressure is applied to the electrochemical element stack S when the lower cover 203 and the upper cover 201 are linked to each other. This clamping pressure is applied by causing predetermined compressional deformation L of the plate-like members 220.

The following is a description of the compressional deformation L.

In the following description, it is supposed that the container 200 is made of a predetermined material Y1, the main portions of the electrochemical element stack S, such as the substrates, are made of a predetermined material Y2, and the plate-like members 220 are made of a predetermined material Y3. The material Y3 has a thermal expansion rate larger than the thermal expansion rates of the materials Y1 and Y2.

Here, the spring constant of each of the plate-like members 220 at room temperature(20° C.) is taken as K20. The spring constant K20 is calculated using, for example, the thickness, the amplitude (height) of the wavelike shape, the pitch of the wave, and the like of the plate-like member 220.

In addition, the spring constant at a temperature (e.g., 700° C.) during power generation by the electrochemical element A is taken as K700. Note that K700 is, for example, about 75% of K20.

Here, clamping pressure per unit area required for the electrochemical element stack S during power generation (e.g., at 700° C.) is taken as P. Here, P is, for example, about 1 to 3 kgf/cm², but is not limited thereto. When the area of the electrochemical element stack S is taken as SB, an applied force F is represented as follows: F=P×SB.

When the temperature rises from room temperature (20° C.) to a high temperature (e.g., 700° C.) during power generation, the thermal expansion lengths of the container 200, the electrochemical element stack S, and the plate-like member 220 in the application direction (here, a direction in which the electrochemical elements A are stacked) are taken as LA, LB, and LC, respectively.

A difference ΔG in the thermal expansion length between the container 200 and the electrochemical element stack S is expressed as follows: ΔG=LA-LB. Here, a difference in the thermal expansion length between the container 200, and the electrochemical element stack S and the plate-like member 220 may be calculated as the difference ΔG in the thermal expansion length. In this case, ΔG is expressed as follows: ΔG=LA-(LB+LC). In the following description, the expression ΔG=LA-LB is used supposing that the plate-like members 220 do not thermally expand, appropriate clamping pressure can be more reliably applied due to the compressional deformation L of the plate-like members 220 during assembly even after the container 200 and the like thermally expand.

Here, the compressional deformation L of the plate-like members 220 at room temperature (20) to keep the clamping pressure P per unit area at a high temperature (e.g., 700° C.) during power generation is calculated using the following expression.

$$\text{L=P×SB/} \left(\text{K700}\right) \text{+ΔG}$$

As described above, after the electrochemical element stack S, the plate-like members 220, and the like are housed in the container 200, the linkage distance between the lower cover 203 and the upper cover 201, and the like are adjusted such that the compressional deformation L calculated as mentioned above is caused in the plate-like members 220, and then the lower cover 203 and the upper cover 201 are sealed through welding or the like. This makes it possible to apply predetermined clamping pressure to the electrochemical element stack S.

### 3) Functions of Plate-Like Members

As mentioned above, the plate-like members 220 constituted by thermally expandable members are arranged on the top flat face and the bottom flat face of the electrochemical element stack S, and elastically support the electrochemical element stack S due to the upper and lower plates 230 applying predetermined clamping pressure thereto.

Here, for example, at least one of the electrochemical element stack S, the container 200, and the like expands when shifting from a low temperature state (e.g., about 20° C. in room-temperature atmosphere) in which the electrochemical elements A do not generate power to a high temperature state (e.g., about 650° C. to about 950° C.) in which the electrochemical elements A generate power. At this time, if a difference in thermal expansion between the electrochemical element stack S and the container 200 occurs, a clearance between the electrochemical element stack S and the container 200 changes between when power is generated (high-temperature state) and when power is not generated (low-temperature state).

With the above-mentioned configuration, the plate-like members 220 are thermally expandable members, and therefore, the plate-like members 220 also thermally expand due to high temperature of the electrochemical elements A during power generation. Accordingly, even when a clearance between the electrochemical element stack S and the container 200 changes due to thermal expansion, the plate-like members 220 apply appropriate clamping pressure to the electrochemical element stack S with the plates 230 being used as pressing faces by utilizing the elastic force that results from thermal expansion of the plate-like members 220 themselves and the elastic force that results from the compressional deformation L caused in advance.

That is, the change of a clearance between the electrochemical element stack S and the container 200 due to thermal expansion can be compensated with the change of the plate-like members 220 due to thermal expansion. Accordingly, appropriate clamping pressure is applied to the electrochemical element stack S even after the above-described clearance has changed. For example, the plate-like members 220 thermally expand and compensate for a clearance between the electrochemical element stack S and the container 200 that has increased in size due to thermal expansion, and thus appropriate clamping pressure is applied to the electrochemical element stack S.

Since the plate-like members 220 are arranged along the flat faces of the electrochemical element stack S and the flat faces of the plates 230, the plate-like members 220 substantially uniformly apply appropriate clamping pressure along the flat faces of the electrochemical element stack S even after the above-described clearance has changed. Accordingly, in the electrochemical module M, it is possible to suppress a decrease in contact areas between the electrochemical elements A and to reduce internal resistance. In addition, since the electrochemical elements A can be brought into appropriate contact with each other to maintain gas-tightness, it is possible to suppress leakage of fuel gas and the like to the outside of the electrochemical elements A and a decrease in the ability to seal in reaction gas.

As described above, a small-size, light-weight, and low-cost electrochemical module in which the electrochemical element stack S and the like can be clamped appropriately even when the electrochemical element stack S and the like expand can be achieved.

In particular, in the above-mentioned embodiment, the plate-like members 220 have a thermal expansion rate larger than the thermal expansion rates of the members included in the container 200. To achieve this relationship, for example, austenite-based stainless steel is employed as the material of the plate-like members 220, and ferrite-based stainless steel, martensite-based stainless steel, a complex between the above-mentioned stainless steel and ceramics, or the like is employed as the material of the container 200. In addition, the material of the electrochemical element stack S is the same as the material of the container 200.

Here, as described above, when the electrochemical element stack S shifts from a low-temperature state in which power is not generated to a high-temperature state in which power is generated, at least one of the electrochemical element stack S and the container 200 thermally expands, and a difference in the thermal expansion amount between the electrochemical element stack S and the container 200 occurs. As a result, a clearance between the electrochemical element stack S and the container 200 increases in size in the high-temperature state compared with the low-temperature state. For example, when the thermal expansion amount of the container 200 is relatively large, the clearance between the electrochemical element stack S and the container 200 further increases in size.

In this embodiment, as described above, the plate-like members 220 have a thermal expansion rate larger than the thermal expansion rates of the members included in the container 200. Accordingly, a clearance between the electrochemical element stack S and the container 200 that has increased in size particularly due to expansion of the container 200 can be compensated with thermal expansion of the plate-like members 220. That is, even when the clearance between the electrochemical element stack S and the container 200 changes due to thermal expansion in a direction in which the clearance significantly increases in size, the above-described clearance can be compensated with the plate-like members 220 that thermally expand more greatly. Accordingly, even after this clearance has changed, appropriate clamping pressure can be substantially uniformly applied along the flat faces of the electrochemical element stack S by utilizing the elastic force that results from the compressional deformation caused in the plate-like members 220 in advance and the elastic force that results from thermal expansion of the plate-like members 220 themselves.

Note that, when the container 200 has a relatively small thermal expansion rate, the thermal expansion amount of the container 200 can be suppressed to a small value, for example, in the case where the container 200 becomes hot during power generation. Thus, an increase in the size of the clearance between the electrochemical element stack S and the container 200 due to thermal expansion can be suppressed. Accordingly, even if the plate-like members 220 have a relatively small thermal expansion rate, after the above-described clearance has changed, appropriate clamping pressure can be substantially uniformly applied along the flat faces of the electrochemical element stack S.

In addition, when the thermal expansion amount of the container 200 is small, the locational shifting, breakage, and the like of the substrates, etc. of the electrochemical elements A caused by expansion of the container 200 can be suppressed.

In the above-mentioned embodiment, the plate-like members 220 are formed in a wavelike shape. Accordingly, the top portions of the wavelike shape of each of the plate-like members 220 are in contact alternately with the flat face of the plate 230 and the flat face of the electrochemical element stack S via the insulator 210, at a plurality of positions that are scattered.

When the clearance between the electrochemical element stack S and the container 200 changes due to expansion of at least one of the electrochemical element stack S and the container 200, a pressing force applied to the plate-like members 220 also changes due to the change of the clearance. The pressing force, which has changed, is elastically received via the plate-like members 220 in a state of being substantially uniformly scattered on the substantially entire flat faces of the electrochemical element stack S and the substantially entire flat faces of the plates 230. This is because the plate-like members 220 are in contact with the flat faces of the electrochemical element stack S and the flat faces of the plates 230 at a plurality of positions that are scattered as described above. Furthermore, when the plate-like members 220 thermally change, the change of the clearance between the electrochemical element stack S and the container 200 is received by the thermal expansion and the elasticity of the plate-like members 220 themselves at the above-described positions.

Accordingly, even when the clearance between the electrochemical element stack S and the container 200 changes due to expansion of the electrochemical element stack S and the like, appropriate clamping pressure in the stacking direction can be substantially uniformly applied along the flat faces of the electrochemical element stack S due to the plate-like members 220. This makes it possible to suppress an increase in internal resistance and a decrease in the ability to seal in reaction gas in the electrochemical module M and to reduce the size and weight of the electrochemical module M.

In this embodiment, the electrochemical element stack S includes SOFCs, which are electrochemical elements. The temperature of the SOFC is as high as, for example, about 650° C. to about 950° C. during power generation. Therefore, the expansion amounts of the electrochemical element stack S, the container 200, and the like increase due to these members shifting from the low-temperature state (e.g., about 20° C. in room-temperature atmosphere) in which power is not generated to the high-temperature state (e.g., about 650° C. to about 950° C.) in which power is generated. In this embodiment, the plate-like members 220 can apply appropriate clamping pressure to the electrochemical element stack S with the plates 230 being used as pressing faces by utilizing a change of the elastic force resulting from thermal expansion of the plate-like members 220 themselves. Accordingly, even when SOFCs that generate power in a high-temperature range are used, this embodiment can be employed to apply appropriate clamping pressure to the electrochemical element stack S.

A reduction in size of the electrochemical module M will be further described. For example, in a case of a configuration in which the peripheral portions of two thick clamping plates are fastened to apply clamping pressure to the electrochemical element stack S, large-size tightening bolts provided with a spring need to be provided, as tightening members, on the outside of the electrochemical module M. However, with the above-mentioned embodiment, it is sufficient that the plate-like members 220 are arranged inside the electrochemical module M, and thus the size of the electrochemical module M can be reduced.

In a case where protruding objects such as large-size tightening bolts are arranged on the outside of the electrochemical module M, heat is likely to be dissipated through such protruding objects of the electrochemical module M during power generation. Since the plate-like members 220 of this embodiment are arranged inside the electrochemical module M, heat dissipation faces can be reduced, thus making it possible to improve the power generation efficiency of the electrochemical module M.

In this embodiment, the clamping pressure is adjusted by the plate-like members 220, and therefore, compared with the case where the clamping pressure applied to the electrochemical element stack S is adjusted using a plurality of large-size tightening bolts or the like, time required to adjust the clamping pressure can be significantly reduced. For example, in a case where the electrochemical element stack S is clamped using a plurality of large-size tightening bolts, it is necessary to adjust the pressure while controlling the torque of the bolts. However, when the plate-like members 220 of this embodiment are used, the plate-like members 220 substantially uniformly apply clamping pressure to the flat faces of the electrochemical element stack S, and therefore, complex torque control as described above is not needed.

### Specific Configuration of Electrochemical Module M

Next, the specific configuration of the electrochemical module M will be described with reference to FIGS. 1 and 4. Details of the electrochemical element stack S shown in FIG. 1 is shown in FIG. 4.

As shown in FIGS. 1 and 4, the electrochemical module M includes: the container 200 (the upper cover 201 and the lower cover 203) that is internally provided with the electrochemical element stack S; the first gas supply portion 61 for supplying first gas from the outside of the container 200 to an internal passage A1 via a supply passage 4; the first gas discharge portion 62 for discharging the first gas used in a reaction; the second gas supply portion 71 for supplying second gas from the outside of the container 200 to flowing portions A2; the second gas discharge portion 72 for discharging the second gas used in a reaction; and an output portion 8 to which output generated by an electrochemical reaction in an electrochemical reaction portion 3 is provided, and the container 200 is internally provided with a distribution chamber 9 for distributing and supplying the second gas supplied from the second gas supply portion 71, to the flowing portions A2.

The distribution chamber 9 is a space located on a side for supplying the second gas to the electrochemical element stack S with respect to the electrochemical element stack S, and the flowing portions A2 are open toward the space and are in communication with the space.

In a state of being held between two collectors 81 and 82, the electrochemical element stack S is provided inside the container 200. The output portion 8 extends from the collectors 81 and 82 and is connected to a power supply target provided outside the container 200 so as to freely supply power thereto. Furthermore, the electrochemical element stack S is housed in the container 200 such that at least one of the collectors 81 and 82 is electrically insulated from the container 200 and the container 200 is hermetically sealed against the first gas.

Accordingly, in the electrochemical module M, the fuel gas is supplied from the first gas supply portion 61 and air is supplied from the second gas supply portion 71, so that the fuel gas enters as indicated by dashed arrows and air enters as indicated by solid arrows as shown in FIGS. 1 and 4.

The fuel gas supplied from the first gas supply portion 61 is introduced into the supply passage 4 through a first penetrated portion 41 of the topmost electrochemical element A of the electrochemical element stack S, and flows from the supply passage 4 partitioned by first annular packing materials 42 (which will be described later in detail) into the internal passage A1 in all of the electrochemical elements A. Moreover, the air supplied from the second gas supply portion 71 temporarily flows into the distribution chamber 9, and then flows into the flowing portions A2 formed between the electrochemical elements A.

Incidentally, when a second plate-like body 2 (a portion of a plate-like support 10 (an example of a metal substrate)) is considered as a base, the internal passage A1 is formed between a first plate-like body 1 (a portion of the plate-like support 10 (an example of a metal substrate)) and the second plate-like body 2 at a position at which a portion of the second plate-like body 2 with a wavelike plate-like shape bulges from the first plate-like body 1, and such a portion comes into contact with the electrochemical reaction portion 3 of the adjacent electrochemical element A and can be electrically connected thereto. On the other hand, a portion of the second plate-like body 2 with a wavelike plate-like shape that is in contact with the first plate-like body 1 is electrically connected to the first plate-like body 1, and the flowing portion A2 is formed between the second plate-like body 2 and the electrochemical reaction portion 3 of the adjacent electrochemical element A.

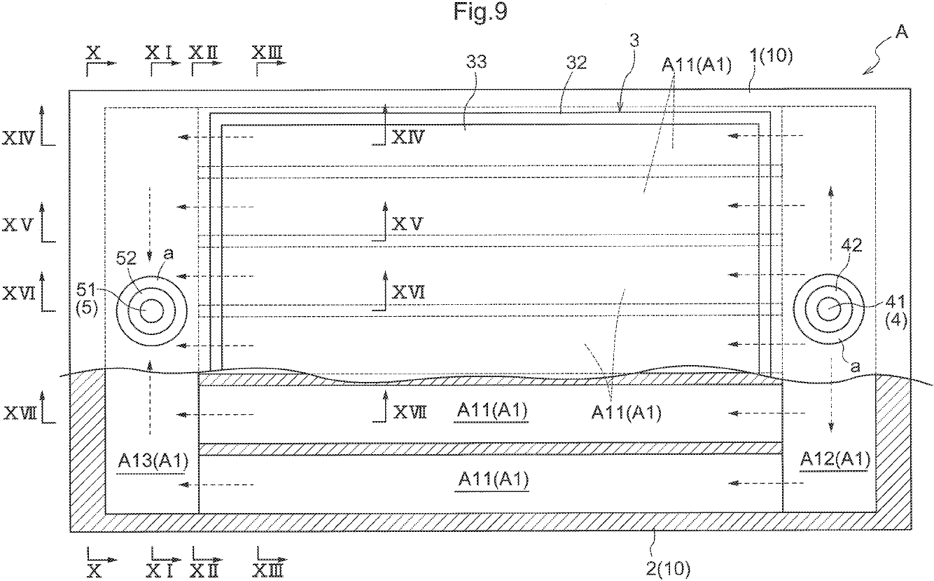

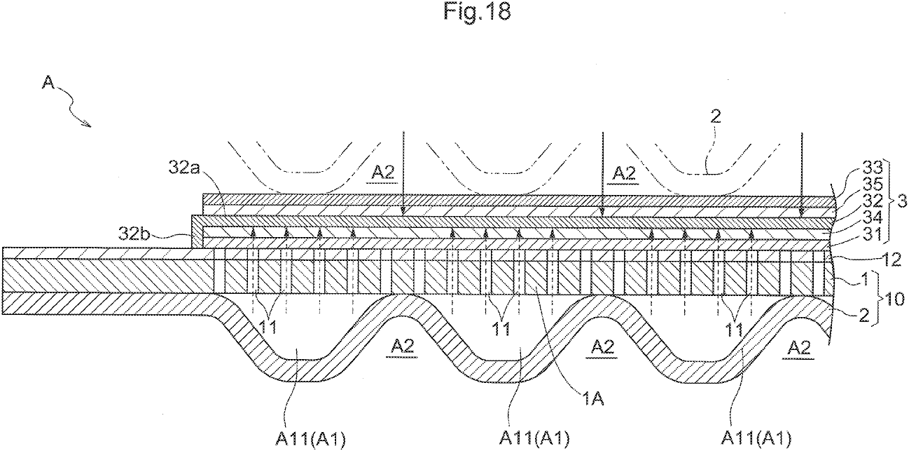

A portion of FIG. 18 shows a cross section of an electrochemical element A including the internal passage A1 and a cross section of an electrochemical element A including the flowing portion A2 that are aligned for the sake of convenience. The fuel gas supplied from the first gas supply portion 61 reaches a distribution portion A12 (see FIGS. 9, 12, and 15), flows and spreads in the width direction of one end portion via the distribution portion A12, and reaches auxiliary passages A11 of the internal passage A1 (see FIGS. 9, 11, and 15). In this case, the first gas can be equally distributed from the distribution portion A12 to the auxiliary passages A11, thus making it possible to allow the electrochemical elements to equally generate electrochemical output.

Then, the fuel gas that has entered the internal passage A1 can enter the electrode layers (first electrodes) 31 and the electrolyte layers 32 via a gas-permeable portion 1A. Moreover, the fuel gas further flows in the internal passage A1 together with the fuel gas used in an electrochemical reaction to a discharge passage 5 formed by second annular packing materials 52 (which will be described later in detail) via confluence portions A13 and a second penetrated portion 51, and is discharged from the first gas discharge portion 62 to the outside of the container 200, together with the fuel gas that was used in an electrochemical reaction and flows from other electrochemical elements A.

On the other hand, the air supplied from the second gas supply portion 71 enters the flowing portions A2 via the distribution chamber 9, and then can enter the counter electrode layers (second electrodes) 33 and the electrolyte layers 32. Moreover, the air further flows in the flowing portions A2 along the electrochemical reaction portions 3 together with air used in an electrochemical reaction, and is discharged from the second gas discharge portion 72 to the outside of the container 200.

With this configuration, the electrochemical elements A are connected in series between the collectors 81 and 82 due to the contact between the second plate-like body 2 and the electrochemical reaction portion 3 of the adjacent electrochemical elements A, and thus power generated following the fuel gas flow and the air flow in the electrochemical reaction portions 3 is extracted from the output portion 8 as composite output. The configuration of the electrochemical element stack S will be described later in detail.

### Modified Examples of Plate-Like Member

(a) In the description above, the plate-like members 220 are thermally expandable members that thermally expand. However, the plate-like members 220 are not limited to thermally expandable members as long as members that can substantially uniformly apply clamping pressure to the flat faces of the electrochemical element stack S when the electrochemical element stack S, the container 200, and the like expand and contract, for example, are used. For example, the plate-like members 220 may be members that have a small thermal expansion rate but have a certain level of elasticity.

The elastic plate-like members 220 are arranged on the top flat face and the bottom flat face of the electrochemical element stack S and extend along these flat faces. The plate-like members 220 elastically support the electrochemical element stack S due to the container 200 applying predetermined clamping pressure thereto via the upper and lower plates 230.

When at least one of the electrochemical element stack S and the container 200 expands, a clearance between the electrochemical element stack S and the container 200 may change between before and after expansion of the electrochemical element stack S and the like. The plate-like members 220 have elasticity, and therefore, the electrochemical element stack S is elastically clamped between the plate-like members 220 in the container 200 due to the elastic force of the plate-like members 220 even if the clearance between the electrochemical element stack S and the container 200 changes. That is, clamping pressure is applied to the plate-like members 220 from the container 200, and thus the electrochemical element stack S is elastically clamped between the two plates 230.

More specifically, when a clearance between the electrochemical element stack S and the container 200 changes due to expansion of at least one of the electrochemical element stack S and the container 200, a pressing force applied to the plate-like members 220 also changes due to the change of the clearance. The pressing force, which has changed, is elastically received by the plate-like members 220 arranged along the flat faces of the electrochemical element stack S and the flat faces of the plates 230 in a state of being substantially uniformly scattered on the substantially entire flat faces of the electrochemical element stack S and the substantially entire flat faces of the plates 230.

Accordingly, even when the clearance between the electrochemical element stack S and the container 200 changes due to expansion of the electrochemical element stack S and the like, appropriate clamping pressure in the stacking direction can be substantially uniformly applied along the flat faces of the electrochemical element stack S due to the plate-like members 220.

Employing the simple configuration as described above in which the plate-like members 220 are arranged along the flat faces of the electrochemical element stack S and the plates 230 in a location between the flat faces of the electrochemical element stack S and the flat faces of the plates 230 and these members are housed in the container 200 makes it possible to form the electrochemical module M in which expansion of the electrochemical element stack S and the like is taken into consideration.

Note that, in the case where the plate-like members 220 are members having a small thermal expansion rate, it is preferable to apply larger clamping pressure when the plate-like members 220, the electrochemical element stack S, and the like are housed in the container 200 and assembled together, compared with the case where the plate-like members 220 are members having a large thermal expansion rate. In this case, during assembly, large repulsive force is generated in the plate-like members 220 due to large clamping pressure. Accordingly, even when the clearance between the electrochemical element stack S and the container 200 increases in size due to expansion of the electrochemical element stack S and the like, and thus the clamping pressure decreases to a certain degree, appropriate clamping pressure can be applied to the electrochemical element stack S.

(b) In the description above, the upper plate-like member 220T and the lower plate-like member 220B are provided, but configurations are also possible in which only one of the plate-like members 220 is provided. However, when the upper plate-like member 220T and the lower plate-like member 220B are provided, clamping pressure can be applied to the electrochemical element stack S from above and below using the plate-like members 220, and thus clamping pressure can be more uniformly applied to the flat faces of the electrochemical element stack S. Accordingly, such a configuration is preferable.

(c) In the description above, the plate-like members 220 are formed in a wavelike shape, but there is no limitation to this shape, and other configurations can also be employed in which the plate-like members 220 are in contact with the electrochemical element stack S, the plates 230, and the like at a plurality of positions that are scattered. For example, the plate-like members 220 may also be formed in a metal honeycomb shape.

The plate-like members 220 may also be in contact with either the flat faces of the electrochemical element stack S or the flat faces of the plates 230 at a plurality of positions that are scattered.

For example, it is also possible that the plate-like members 220 are in contact with the flat faces of the electrochemical element stack S at a plurality of positions that are scattered, and are in surface contact with the flat faces of the plates 230. In this case, a force applied due to expansion of the electrochemical element stack S and the like is scattered and received by the portions of the plate-like members 220 that are in contact with the electrochemical element stack S.

Moreover, for example, it is also possible that the plate-like members 220 are in surface contact with the flat faces of the electrochemical element stack S, and are in contact with the flat faces of the plates 230 at a plurality of positions. In this case, a force applied due to expansion of the electrochemical element stack S and the like is scattered and received by the portions of the plate-like members 220 that are in contact with the flat faces of the plates 230.

(d) In the description above, the plate-like members 220 have a thermal expansion rate larger than the thermal expansion rates of the members included in the container 200. However, there is no limitation to such a relationship between the thermal expansion rates as long as a clearance between the electrochemical element stack S and the container 200 formed due to thermal expansion can be compensated with expansion of the plate-like members 220.

For example, the plate-like members 220 may have a thermal expansion rate similar to, or smaller than, the thermal expansion rates of the members included in the container 200.

(e) In the description above, the plate-like members 220 are used to adjust a change of the clearance between the electrochemical element stack S and the container 200 due to expansion. However, the plate-like members 220 can also be employed to adjust a change of the clearance between the electrochemical element stack S and the container 200 due to contraction.

(f) The above-mentioned plate-like members 220 can receive expansion and contraction of the electrochemical element stack S, the container 200, and the like caused by a change of the temperature due to power generation as well as changes of, for example, vibration, external pressure, humidity, and outside air temperature that act on the electrochemical module M.

(g) In the description above, the electrochemical module M is provided with functional layers such as the insulators 210 having insulating properties. The electrochemical module M may also be provided with separate functional layers in addition to, or instead of, the above-mentioned functional layers.

(h) In the description above, the lower cover 203 and the upper cover 201 are linked to each other through welding. However, the technique for linking the lower cover 203 and the upper cover 201 to each other is not limited to welding, and the lower cover 203 and the upper cover 201 may be linked to each other using, for example, bolts or the like.

### Specific Configuration of Electrochemical Element Stack S

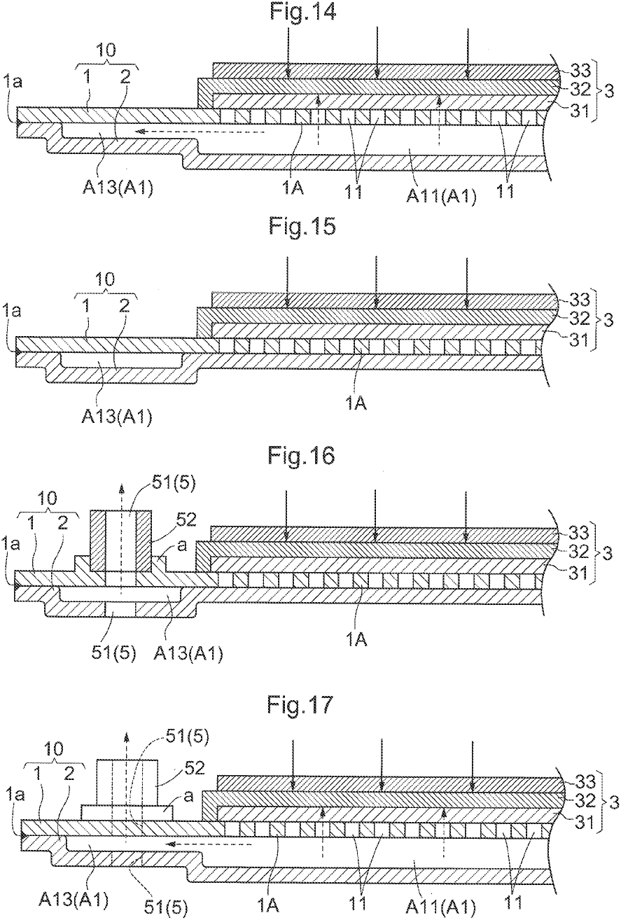

Next, the specific configuration of the electrochemical element stack S will be described. The electrochemical element stack S is formed by stacking a plurality of electrochemical elements A. The electrochemical element A will be described with reference to FIGS. 9 to 18.

### Electrochemical Element

As shown in FIGS. 9 to 17, the electrochemical element A includes a plate-like support 10 provided with the internal passage A1 formed between the faces of the conductive first plate-like body 1 and the conductive second plate-like body 2 that are opposed to each other. The plate-like support 10 includes the gas-permeable portion 1A through which gas is permeable between the internal passage A1, which is located inside the plate-like support 10, and the outside at one or more portions of the first plate-like body 1 and the second plate-like body 2 included in the plate-like support 10, and the electrochemical reaction portion 3 that entirely or partially covers the gas-permeable portion 1A and includes the film-like electrode layer 31, the film-like electrolyte layer 32, and the film-like counter electrode layer 33 in the stated order (see FIGS. 13 to 17). Moreover, the first penetrated portion 41 forming the supply passage 4 for supplying first gas that is one of reducing component gas such as fuel gas and oxidative component gas such as air from the outside in the surface penetration direction to the internal passage A1 is provided at one end portion of the plate-like support 10, and the second penetrated portion 51 forming the discharge passage 5 for discharging the first gas that has passed through the internal passage A1 to the outside in the surface penetration direction of the plate-like support is provided at the other end portion of the plate-like support 10 (see FIGS. 9, 11, 16, and 17). Note that it is understood that the supply passage 4 and the like and the discharge passage 5 and the like are symmetrical to each other and have a similar structure.

### Plate-Like Support

The first plate-like body 1 serves to maintain the strength of the electrochemical element A by supporting the electrochemical reaction portion 3 that includes the electrode layer 31, the electrolyte layer 32, and the counter electrode layer 33. A material that has excellent electron conductivity, thermal resistance, oxidation resistance, and corrosion resistance is used as the material of the first plate-like body 1. Examples thereof include ferrite-based stainless steel, austenite-based stainless steel, and a nickel-based alloy. In particular, an alloy containing chromium is favorably used. In this embodiment, the first plate-like body 1 is made of a Fe-Cr based alloy that contains Cr in an amount of 18 mass% or more and 25 mass% or less, but a Fe—Cr based alloy that contains Mn in an amount of 0.05 mass% or more, a Fe-Cr based alloy that contains Ti in an amount of 0.15 mass% or more and 1.0 mass% or less, a Fe—Cr based alloy that contains Zr in an amount of 0.15 mass% or more and 1.0 mass% or less, a Fe—Cr based alloy that contains Ti and Zr, a total content of Ti and Zr being 0.15 mass% or more and 1.0 mass% or less, and a Fe—Cr based alloy that contains Cu in an amount of 0.10 mass% or more and 1.0 mass% or less are particularly favorable.

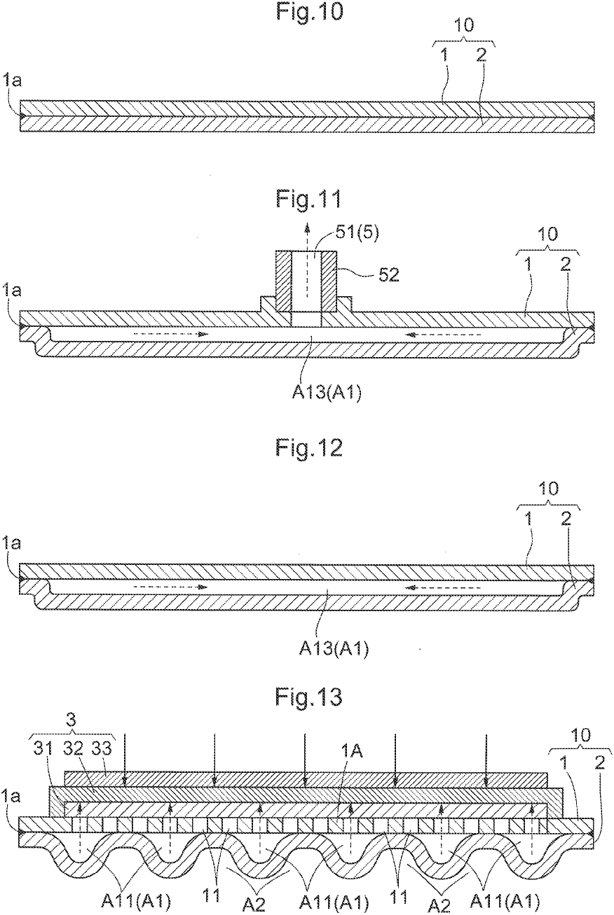

The plate-like support 10 is formed by welding and integrating peripheral portions 1a of the second plate-like body 2 and the first plate-like body 1 in a state in which the second plate-like body 2 and the first plate-like body 1 are stacked (see FIGS. 10 to 17). The second plate-like body 2 may be divided into a plurality of portions with respect to the first plate-like body 1. On the contrary, the first plate-like body 1 may be divided into a plurality of portions with respect to the second plate-like body 2. Another means such as bonding or fitting can be employed as the integrating means instead of welding. Portions other than the peripheral portions 1a may be integrated as long as the internal passage can be formed separate from the outside.

The first plate-like body 1 includes the gas-permeable portion 1A obtained by forming a large number of through holes 11 that penetrate the surface on the front side and the surface on the back side (see FIGS. 13 to 17). Note that the through holes 11 can be formed in the first plate-like body 1 by, for example, laser processing or the like. The through holes 11 have a function of transmitting gas from the surface on the back side of the first plate-like body 1 to the surface on the front side thereof. It is preferable that the gas-permeable portion 1A is provided in a region of the first plate-like body 1 that is smaller than the region in which the electrode layer 31 is provided.

A metal oxide layer 12 (which will be described later: see FIG. 18) serving as a diffusion suppressing layer is provided on the surface of the first plate-like body 1. That is, the diffusion suppressing layer is formed between the first plate-like body 1 and the electrode layer 31, which will be described later. The metal oxide layer 12 is provided on not only the surface of the first plate-like body 1 exposed to the outside but also the surface (interface) that is in contact with the electrode layer 31. The metal oxide layer 12 can also be provided on the inner faces of the through holes 11. Element interdiffusion that occurs between the first plate-like body 1 and the electrode layer 31 can be suppressed due to this metal oxide layer 12. For example, when ferrite-based stainless steel containing chromium is used in the first plate-like body 1, the metal oxide layer 12 is mainly made of a chromium oxide. The metal oxide layer 12 containing the chromium oxide as the main component suppresses diffusion of chromium atoms and the like of the first plate-like body 1 to the electrode layer 31 and the electrolyte layer 32. The metal oxide layer 12 need only have such a thickness that allows both high diffusion preventing performance and low electric resistance to be achieved.

The metal oxide layer 12 can be formed using various techniques, but it is favorable to use a technique of oxidizing the surface of the first plate-like body 1 to obtain a metal oxide. Also, the metal oxide layer 12 may be formed on the surface of the first plate-like body 1 by using a spray coating technique (a technique such as thermal spraying technique, an aerosol deposition technique, an aerosol gas deposition technique, a powder jet deposition technique, a particle jet deposition technique, or a cold spraying technique), a PVD technique such as a sputtering technique or PLD technique, or a CVD technique, or may be formed by plating and oxidation treatment. Furthermore, the metal oxide layer 12 may also contain a spinel phase that has high electrical conductivity, or the like.

When a ferrite-based stainless steel material is used to form the first plate-like body 1, its thermal expansion coefficient is close to that of YSZ (yttria-stabilized zirconia), GDC (gadolinium-doped ceria; also called CGO), or the like, which is used as the material of the electrode layer 31 and the electrolyte layer 32. Accordingly, even if low and high temperature cycling is repeated, the electrochemical element Ais not likely to be damaged. Therefore, this is preferable due to being able to realize an electrochemical element A that has excellent long-term durability. Note that the first plate-like body 1 is provided with a plurality of through holes 11 that penetrate the surface on the front side and the surface on the back side. Note that the through holes 11 can be provided in the first plate-like body 1 through, for example, mechanical, chemical, or optical piercing processing. The through holes 11 have a function of transmitting gas from the surface on the back side of the first plate-like body 1 to the surface on the front side thereof. Porous metal can also be used to impart gas permeability to the first plate-like body 1. For example, a metal sintered body, a metal foam, or the like can also be used as the first plate-like body 1.

The second plate-like body 2 is formed in a wavelike shape such that the internal passage A1 that includes a plurality of auxiliary passages A11 leading from one end side to the other end side is formed in the region opposed to the gas-permeable portion 1A of the first plate-like body 1 (see FIGS. 9 and 13). Both faces on the front side and the back side of the second plate-like body 2 are formed in a wavelike shape. A face on a side opposite to the face that delimits and forms the internal passage A1 is electrically connected to the electrochemical reaction portion 3 of the adjacent electrochemical element A, and passages formed near the portions of the wavelike second plate-like body 2 that are in contact with the first plate-like body 1 function as the flowing portion A2. The plurality of auxiliary passages A11 are provided in parallel along the long side of the rectangular plate-like support 10, and form the internal passage A1 extending from the supply passage 4 provided at one end portion to the discharge passage 5 provided at the other end portion.

A connection portion where the first penetrated portion 41 and the internal passage A1 are connected to each other is provided with the distribution portion A12 that is formed by bulging the second plate-like body 2 downward from the portion thereof in contact with the first plate-like body 1 and distributes first gas supplied from the first penetrated portion 41 to the auxiliary passages A11 (see FIG. 9), and a connection portion where the second penetrated portion 51 and the internal passage A1 are connected to each other is provided with the confluence portion A13 that is formed by bulging the second plate-like body 2 downward from the portion thereof in contact with the first plate-like body 1, and collects the first gas that has passed through the auxiliary passages A11 and introduces it into the second penetrated portion 51 (see FIGS. 9, 11, 12, and 14 to 17; it is understood that the supply passage 4 and the like and the discharge passage 5 and the like are symmetrical to each other and have a similar structure). The material of the second plate-like body 2 is preferably a heat resistant metal, and more preferably the same material as that of the first plate-like body 1 from the viewpoint of reducing a difference in thermal expansion between the second plate-like body 2 and the first plate-like body 1 and ensuring the reliability of the joining state due to welding or the like.

The electrode layer 31, the electrolyte layer 32, the counter electrode layer 33, and the like are formed on the top face of the plate-like support 10 (an example of a metal support) constituted by the first plate-like body 1 and the second plate-like body 2 described above. That is, the electrode layer 31, the electrolyte layer 32, the counter electrode layer 33, and the like are supported by the plate-like support 10, and it is possible to realize an electrochemical element A that has high strength and excellent reliability and durability. A plate-like support 10 that is made of a metal has excellent processability, and is thus preferable. Furthermore, even if an inexpensive metal is used for the plate-like support 10, the obtained plate-like support 10 has high strength, and accordingly, the thicknesses of the electrode layer 31, the electrolyte layer 32, and the like, which are expensive, can be reduced, and a low-cost electrochemical element A can be realized with a reduced material cost and a reduced processing cost, which is preferable.

### Electrochemical Reaction Portion, Electrode Layer

As shown in FIGS. 13 to 18, the electrode layer 31 can be provided as a thin layer in a region that is larger than the region provided with the through holes 11, on the front face of the first plate-like body 1. When it is formed as a thin layer, the thickness can be set to, for example, approximately 1 µm to 100 µm, and preferably 5 µm to 50 µm. This thickness makes it possible to ensure sufficient electrode performance while also achieving cost reduction by reducing the used amount of expensive electrode layer material. The region provided with the through holes 11 is entirely covered by the electrode layer 31. That is, the through holes 11 are formed inside the region of the first plate-like body 1 in which the electrode layer 31 is formed. In other words, all the through holes 11 are provided facing the electrode layer 31.

The inside and the surface of the electrode layer 31 are provided with a plurality of pores in order to impart gas permeability to the electrode layer 31.

That is, the electrode layer 31 is formed as a porous layer. The electrode layer 31 is formed, for example, to have a denseness of 30% or more and less than 80%. Regarding the size of the pores, a size suitable for smooth progress of an electrochemical reaction can be selected as appropriate. Note that the “denseness” is a ratio of the material of the layer to the space and can be represented by a formula “1 -porosity”, and is equivalent to relative density.

For example, a composite material such as NiO—GDC, Ni—GDC, NiO—YSZ, Ni—YSZ, CuO—CeO₂, or Cu—CeO₂ can be used as the material of the electrode layer 31. In these examples, GDC, YSZ, and CeO₂ can be called the aggregate of the composite material. Note that it is preferable to form the electrode layer 31 using low-temperature calcining (not performing calcining treatment in a high temperature range of higher than 1100° C., but rather performing a wet process using calcining treatment in a low temperature range, for example), a spray coating technique (a technique such as a thermal spraying technique, an aerosol deposition technique, an aerosol gas deposition technique, a powder jet deposition technique, a particle jet deposition technique, or a cold spraying technique), a PVD technique (e.g., a sputtering technique or a pulse laser deposition technique), a CVD technique, or the like. Due to these processes that can be used in a low temperature range, a favorable electrode layer 31 is obtained, for example, without using calcining in a high temperature range of higher than 1100° C. Therefore, this is preferable due to being able to prevent damage to the first plate-like body 1, suppress element interdiffusion between the first plate-like body 1 and the electrode layer 31, and realize an electrochemical element A that has excellent durability. Furthermore, using low-temperature calcining makes it possible to facilitate handling of raw materials and is thus more preferable.

### Intermediate Layer

An intermediate layer 34 can be formed as a thin layer on the electrode layer 31 so as to cover the electrode layer 31. When it is formed as a thin layer, the thickness can be set to, for example, approximately 1 µm to 100 µm, preferably approximately 2 µm to 50 µm, and more preferably approximately 4 µm to 25 µm. This thickness makes it possible to ensure sufficient performance while also achieving cost reduction by reducing the used amount of expensive material of the intermediate layer 34. YSZ (yttria-stabilized zirconia), SSZ (scandia-stabilized zirconia), GDC (gadolinium-doped ceria), YDC (yttrium-doped ceria), SDC (samarium-doped ceria), or the like can be used as the material of the intermediate layer 34. In particular, ceria-based ceramics are favorably used.

It is preferable to form the intermediate Layer 34 using low-temperature calcining (not performing calcining treatment in a high temperature range of higher than 1100° C., but rather performing a wet process using calcining treatment in a low temperature range, for example), a spray coating technique (a technique such as a thermal spraying technique, an aerosol deposition technique, an aerosol gas deposition technique, a powder jet deposition technique, a particle jet deposition technique, or a cold spraying technique), a PVD technique (e.g., a sputtering technique or a pulse laser deposition technique), a CVD technique, or the like. Due to these film formation processes that can be used in a low temperature range, an intermediate layer 34 is obtained, for example, without using calcining in a high temperature range of higher than 1100° C. Therefore, it is possible to prevent damage to the first plate-like body 1, suppress element interdiffusion between the first plate-like body 1 and the electrode layer 31, and realize an electrochemical element A that has excellent durability. Furthermore, using low-temperature calcining makes it possible to facilitate handling of raw materials and is thus more preferable.

It is preferable that the intermediate layer 34 has oxygen ion (oxide ion) conductivity. It is more preferable that the intermediate layer 34 has both oxygen ion (oxide ion) conductivity and electron conductivity, namely mixed conductivity. The intermediate layer 34 that has these properties is suitable for application to the electrochemical element A.

### Electrolyte Layer

As shown in FIGS. 13 to 18, the electrolyte layer 32 is formed as a thin layer on the intermediate layer 34 so as to cover the electrode layer 31 and the intermediate layer 34. The electrolyte layer 32 can also be formed as a thin film having a thickness of 10 µm or less. Specifically, the electrolyte layer 32 is provided on both the intermediate layer 34 and the first plate-like body 1 (spanning the intermediate layer 34 and the first plate-like body 1). Configuring the electrolyte layer 32 in this manner and joining the electrolyte layer 32 to the first plate-like body 1 make it possible to allow the electrochemical element to have excellent toughness as a whole.

Also, as shown in FIG. 13, the electrolyte layer 32 is provided in a region that is larger than the region provided with the through holes 11, on the front face of the first plate-like body 1. That is, the through holes 11 are formed inside the region of the first plate-like body 1 in which the electrolyte layer 32 is formed.

The leakage of gas from the electrode layer 31 and the above-mentioned intermediate layer (not illustrated) can be suppressed in the vicinity of the electrolyte layer 32. A description of this will be given. When the electrochemical element A is used as a constituent element of an SOFC, gas is supplied from the back side of the first plate-like body 1 through the through holes 11 to the electrode layer 31 during the operation of the SOFC. In a region where the electrolyte layer 32 is in contact with the first plate-like body 1, leakage of gas can be suppressed without providing another member such as a gasket. Note that, although the entire vicinity of the electrode layer 31 is covered by the electrolyte layer 32 in this embodiment, a configuration in which the electrolyte layer 32 is provided on the electrode layer 31 and the above-mentioned intermediate layer 34 and a gasket or the like is provided in its vicinity may also be adopted.

Electrolyte materials having oxygen ion conductivity such as YSZ (yttria-stabilized zirconia), SSZ (scandia-stabilized zirconia), GDC (gadolinium-doped ceria), YDC (yttrium-doped ceria), SDC (samarium-doped ceria), LSGM (strontium- and magnesium-doped lanthanum gallate), and the like, and electrolyte materials having hydrogen ion conductivity such as perovskite oxides can be used as the material of the electrolyte layer 32. In particular, zirconia-based ceramics are favorably used. Using zirconia-based ceramics for the electrolyte layer 32 makes it possible to increase the operation temperature of the SOFC in which the electrochemical element A is used compared with the case where ceria-based ceramics and various materials having hydrogen ion conductivity are used. For example, when the electrochemical element A is used in the SOFC, by adopting a system configuration in which a material such as YSZ that can exhibit high electrolyte performance even in a high temperature range of approximately 650° C. or higher is used as the material of the electrolyte layer 32, a hydrocarbon-based raw fuel material such as city gas or LPG is used as the raw fuel for the system, and the raw fuel material is reformed into anode gas of the SOFC through steam reforming or the like, it is thus possible to construct a high-efficiency SOFC system in which heat generated in a cell stack of the SOFC is used to reform raw fuel gas.

It is preferable to form the electrolyte layer 32 using low-temperature calcining (not performing calcining treatment in a high temperature range of higher than 1100° C., but rather performing a wet process using calcining treatment in a low temperature range, for example), a spray coating technique (a technique such as a thermal spraying technique, an aerosol deposition technique, an aerosol gas deposition technique, a powder jet deposition technique, a particle jet deposition technique, or a cold spraying technique), a PVD technique (e.g., a sputtering technique or a pulse laser deposition technique), a CVD (chemical vapor deposition) technique, or the like. Due to these film formation processes that can be used in a low temperature range, an electrolyte layer 32 that is dense and has high gas-tightness and gas barrier properties is obtained, for example, without using calcining in a high temperature range of higher than 1100° C. Therefore, it is possible to prevent damage to the first plate-like body 1, suppress element interdiffusion between the first plate-like body 1 and the electrode layer 31, and realize an electrochemical element A that has excellent performance and durability. In particular, using low-temperature calcining, a spray coating technique, or the like makes it possible to realize a low-cost element and is thus preferable. Furthermore, using a spray coating technique makes it easy to obtain, in a low temperature range, an electrolyte layer that is dense and has high gas-tightness and gas barrier properties, and is thus more preferable.

The electrolyte layer 32 is given a dense configuration in order to block gas leakage of anode gas and cathode gas and exhibit high ion conductivity. The electrolyte layer 32 preferably has a denseness of 90% or more, more preferably 95% or more, and even more preferably 98% or more. When the electrolyte layer 32 is formed as a uniform layer, the denseness is preferably 95% or more, and more preferably 98% or more. When the electrolyte layer 32 has a multilayer configuration, at least a portion thereof preferably includes a layer (dense electrolyte layer) having a denseness of 98% or more, and more preferably a layer (dense electrolyte layer) having a denseness of 99% or more. The reason for this is that an electrolyte layer that is dense and has high gas-tightness and gas barrier properties can be easily formed due to such a dense electrolyte layer being included as a portion of the electrolyte layer even when the electrolyte layer has a multilayer configuration.

### Reaction Preventing Layer

A reaction preventing layer 35 can be formed as a thin layer on the electrolyte layer 32. When it is formed as a thin layer, the thickness can be set to, for example, approximately 1 µm to 100 µm, preferably approximately 2 µm to 50 µm, and more preferably approximately 3 µm to 15 µm. This thickness makes it possible to ensure sufficient performance while also achieving cost reduction by reducing the used amount of expensive reaction preventing layer material. The material of the reaction preventing layer need only be capable of preventing reactions between the component of the electrolyte layer 32 and the component of the counter electrode layer 33. For example, a ceria-based material or the like is used. Materials that contain at least one element selected from the group consisting of Sm, Gd, and Y are favorably used as the material of the reaction preventing layer 35. It is preferable that at least one element selected from the group consisting of Sm, Gd, and Y is contained, and the total content of these elements is 1.0 mass% or more and 10 mass% or less. Introducing the reaction preventing layer 35 between the electrolyte layer 32 and the counter electrode layer 33 effectively suppresses reactions between the material constituting the counter electrode layer 33 and the material constituting the electrolyte layer 32 and makes it possible to improve long-term stability in the performance of the electrochemical element A. Forming the reaction preventing layer 35 using, as appropriate, a method through which the reaction preventing layer 35 can be formed at a treatment temperature of 1100° C. or lower makes it possible to suppress damage to the first plate-like body 1, suppress element interdiffusion between the first plate-like body 1 and the electrode layer 31, and realize an electrochemical element A that has excellent performance and durability, and is thus preferable. For example, the reaction preventing layer 35 can be formed using, as appropriate, low-temperature calcining (not performing calcining treatment in a high temperature range of higher than 1100° C., but rather performing a wet process using calcining treatment in a low temperature range, for example), a spray coating technique (a technique such as a thermal spraying technique, an aerosol deposition technique, an aerosol gas deposition technique, a powder jet deposition technique, a particle jet deposition technique, or a cold spraying technique), a PVD technique (e.g., a sputtering technique or a pulse laser deposition technique), a CVD technique, or the like. In particular, using low-temperature calcining, a spray coating technique, or the like makes it possible to realize a low-cost element and is thus preferable. Furthermore, using low-temperature calcining makes it possible to facilitate handling of raw materials and is thus more preferable.

### Counter Electrode Layer

As shown in FIGS. 13 to 18, the counter electrode layer 33 can be formed as a thin layer on the electrolyte layer 32 or the reaction preventing layer 35. When it is formed as a thin layer, the thickness can be set to, for example, approximately 1 µm to 100 µm, and preferably 5 µm to 50 µm. This thickness makes it possible to ensure sufficient electrode performance while also achieving cost reduction by reducing the used amount of expensive counter electrode layer material. For example, a complex oxide such as LSCF or LSM, or a ceria-based oxide, or a mixture thereof can be used as the material of the counter electrode layer 33, for example. In particular, it is preferable that the counter electrode layer 33 includes a perovskite oxide containing two or more elements selected from the group consisting of La, Sr, Sm, Mn, Co, and Fe. The counter electrode layer 33 constituted by the above-mentioned material functions as a cathode.

Note that forming the counter electrode layer 33 using, as appropriate, a method through which the counter electrode layer 33 can be formed at a treatment temperature of 1100° C. or lower makes it possible to suppress damage to the first plate-like body 1, suppress element interdiffusion between the first plate-like body 1 and the electrode layer 31, and realize an electrochemical element A that has excellent performance and durability, and is thus preferable. For example, the reaction preventing layer 35 can be formed using, as appropriate, low-temperature calcining (not performing calcining treatment in a high temperature range of higher than 1100° C., but rather performing a wet process using calcining treatment in a low temperature range, for example), a spray coating technique (a technique such as a thermal spraying technique, an aerosol deposition technique, an aerosol gas deposition technique, a powder jet deposition technique, a particle jet deposition technique, or a cold spraying technique), a PVD technique (e.g., a sputtering technique or a pulse laser deposition technique), a CVD technique, or the like. In particular, using low-temperature calcining, a spray coating technique, or the like makes it possible to realize a low-cost element and is thus preferable. Furthermore, using low-temperature calcining makes it possible to facilitate handling of raw materials and is thus more preferable.

By configuring the electrochemical reaction portion 3 as described above, the electrochemical element A can be used as a power generating cell for a solid oxide fuel cell when the electrochemical reaction portion 3 is allowed to function as a fuel cell (electrochemical power generating cell). For example, fuel gas containing hydrogen serving as first gas is supplied from the back face of the first plate-like body 1 through the through holes 11 to the electrode layer 31, air serving as second gas is supplied to the counter electrode layer 33 serving as a counter electrode of the electrode layer 31, and the temperature is maintained at the operation temperature of, for example, approximately 700° C. As a result, the oxygen O₂ included in air reacts with electrons e⁻ in the counter electrode layer 33, thus producing oxygen ions O²⁻. The oxygen ions O²⁻ move through the electrolyte layer 32 to the electrode layer 31. In the electrode layer 31, the hydrogen H₂ included in the supplied fuel gas reacts with the oxygen ions O²⁻, thus producing water H₂O and electrons e⁻.

When the electrolyte layer 32 is made of an electrolyte material having hydrogen ion conductivity, hydrogen H₂ included in the fuel gas flowing in the electrode layer 31 releases electrons e⁻, thus producing hydrogen ions H⁺. The hydrogen ions H⁺ move to the counter electrode layer 33 through the electrolyte layer 32. In the counter electrode layer 33, oxygen O₂ included in air, hydrogen ions H⁺, and electrons e⁻ react with each other to produce water H₂O.

With these reactions, an electromotive force as electrochemical output is generated between the electrode layer 31 and the counter electrode layer 33. In this case, the electrode layer 31 functions as a fuel electrode (anode) of the fuel cell, and the counter electrode layer 33 functions as an air electrode (cathode).

Although omitted in FIGS. 13 to 17, the intermediate layer 34 is provided between the electrode layer 31 and the electrolyte layer 32 of the electrochemical reaction portion 3 of this embodiment as shown in FIG. 18. Furthermore, the reaction preventing layer 35 is provided between the electrolyte layer 32 and the counter electrode layer 33.

### Electrochemical Element Stack

As shown in FIG. 4, the electrochemical element stack S includes a plurality of electrochemical elements A, and the electrochemical elements A are stacked and arranged such that the plate-like support 10 included in one of the adjacent electrochemical elements A is opposed to the plate-like support 10 included in the other, the outer face of the second plate-like body 2, which is different from the first plate-like body 1 on which the electrochemical reaction portion 3 is arranged, in the plate-like support 10 included in one of the adjacent electrochemical elements Ais electrically connected to the outer face of the first plate-like body 1 in the plate-like support 10 included in the other, and the flowing portion A2 through which the second gas flows along the two outer faces is formed between the two outer faces. As a method for electrically connecting the two outer faces, a method for simply bringing electroconductive surfaces into contact with each other, a method for applying contact pressure to the contact faces, a method for reducing contact resistance by providing a highly electroconductive material therebetween, or the like can be employed. Specifically, the above-mentioned configuration is obtained by lining up the rectangular electrochemical elements in the state in which the first penetrated portions 41 at one end and the second penetrated portions 51 at the other end are respectively aligned and the electrochemical reaction portions of the electrochemical elements face upward, and stacking the electrochemical elements with the first annular packing materials 42 being provided between the first penetrated portions 41 and the second annular packing materials 52 being provided between the second penetrated portions 51.

The first penetrated portion 41 forming the supply passage 4 for supplying first gas that is one of reducing component gas and oxidative component gas from the outside in the surface penetration direction to the internal passage A1 is provided at one end in the longitudinal direction of the rectangular plate-like support 10, the first annular packing material 42 serving as an annular packing material for separating the first penetrated portion 41 that is formed on each of the two outer faces of the plate-like member 10 from the flowing portion A2 is provided in the flowing portion A2, and the supply passage 4 for supplying the first gas to the internal passage A1 is formed by the first penetrated portion 41 and the first annular packing material 42 in the plate-like support 10. Note that an annular bulging portion a is provided around a portion of the first plate-like body 1 with which the first annular packing material 42 is in contact, on a face of the first plate-like body 1 on a side opposite to the internal passage A1, thus making it easy to position the first annular packing material 42 in the direction extending along the face of the first plate-like body 1.

Moreover, the other end side of the plate-like support 10 is provided with the second penetrated portion 51 forming the discharge passage 5 for discharging the first gas flowing in the internal passage A1 to the outside in the surface penetration direction of the plate-like support 10, the second penetrated portion 51 has a configuration in which the first gas flows therein in the state of being separated from the second gas, the second annular packing material 52 serving as an annular packing material for separating the second penetrated portion 51 that is formed on each of the two outer faces of the plate-like support 10 from the flowing portion A2 is provided in the flowing portion A2, and the discharge passage 5 for discharging the first gas flowing in the internal passage A1 is formed by the second penetrated portion 51 and the second annular packing material 52.

### Annular Packing Material

Next, the first annular packing material 42 and the second annular packing material 52 will be described.

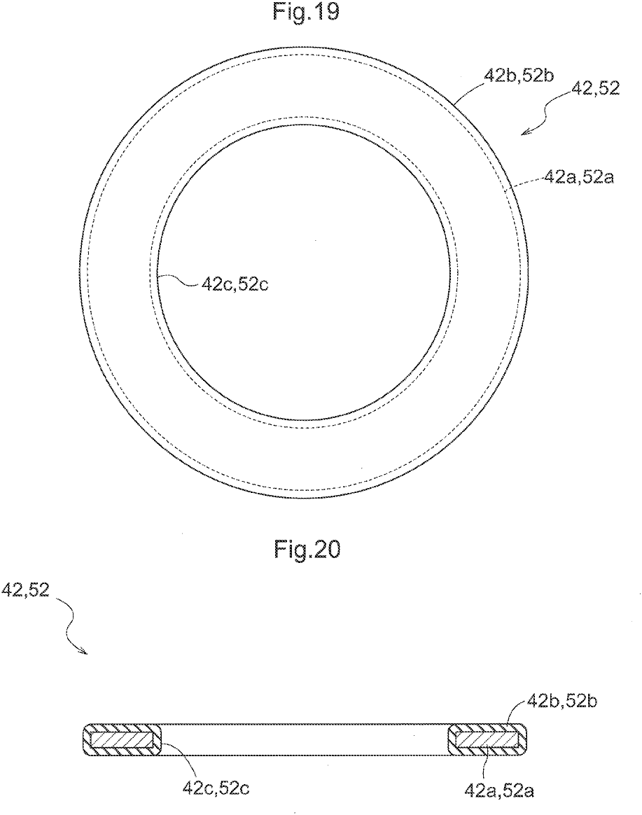

As shown in FIGS. 19 and 20, the annular packing materials 42 and 52 of this embodiment respectively include metal materials 42a and 52a constituted by thermally expandable members that thermally expand, and insulating metal oxide layers 42b and 52b. Through holes 42c and 52c are formed inside the metal materials 42a and 52a and the metal oxide layers 42b and 52b that are formed in an annular shape in the top view. Seal areas involved in sealing by the metal materials 42a and 52a and the metal oxide layers 42b and 52b have an annular shape. With the annular packing materials 42 and 52, the first penetrated portions 41 are in communication with each other via the through holes 42c while the second penetrated portions 51 are in communication with each other via the through holes 52c, and the seal areas seal between the adjacent electrochemical elements A.

As shown in FIG. 2, in the annular packing materials 42 and 52 of this embodiment, the metal materials 42a and 52a are constituted by annular flat plates, and the metal oxide layers 42b and 52b cover the entire surfaces of the metal materials 42a and 52a including the top faces and the bottom faces thereof.

The external shapes of the annular packing materials 42 and 52 in a plan view are not limited to a circular shape, and may be any shape as long as it is an annular shape. The annular shape includes any of an annular circle, an annular ellipse, an annular square, an annular polygon, and the like.

Examples of constitutional materials of the metal materials 42a and 52a include ferrite-based stainless steel, austenite-based stainless steel, Inconel, copper, and an invar material. It is preferable that the metal materials 42a and 52a include at least one selected from the group consisting of ferrite-based stainless steel, austenite-based stainless steel, Inconel, copper, and an invar material.

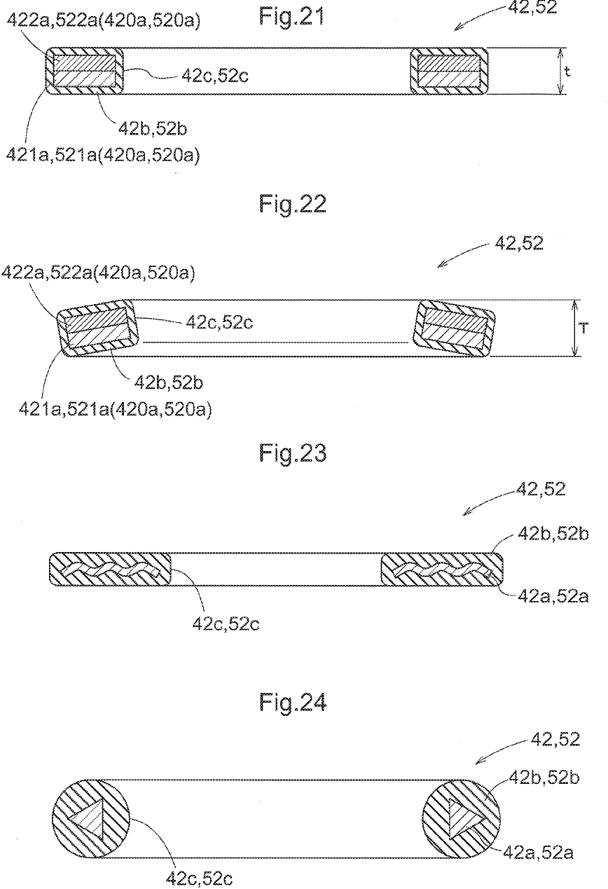

As shown in FIG. 21, the metal materials 42a and 52a may also be constituted by bimetals 420a and 520a that are obtained by bonding metals 421a and 521a with a small thermal expansion coefficient and metals 422a and 522a with a large thermal expansion coefficient to each other through, for example, rolling. The bimetals 420a and 520a are each obtained by bonding two types of metal plates that differ in a thermal expansion rate, and change their shapes into specific shapes in response to the temperature change.

When the bimetals 420a and 520a are used for the metal materials 42a and 52a, it is desirable that, as the temperatures of the bimetals 420a and 520a themselves rise, the bimetals 420a and 520a warp and thus the shapes thereof change from a flat-plate shape shown in FIG. 21 to an arc shape shown in FIG. 22, so that the width in the thickness direction increases (T>t). For example, if the bimetals 420a and 520a have configurations in which invar materials (with a thermal expansion rate of 0.2×10⁻⁵/°C) are used as the metals 421a and 521a with a small thermal expansion coefficient, SUS316 (with a thermal expansion rate of 1.8×10⁻⁵/°C) is used as the metals 422a and 522a with a large thermal expansion coefficient, and t is 0.5 mm, T is 0.68 mm when the temperatures of the bimetals 420a and 520a themselves rise to 700° C.

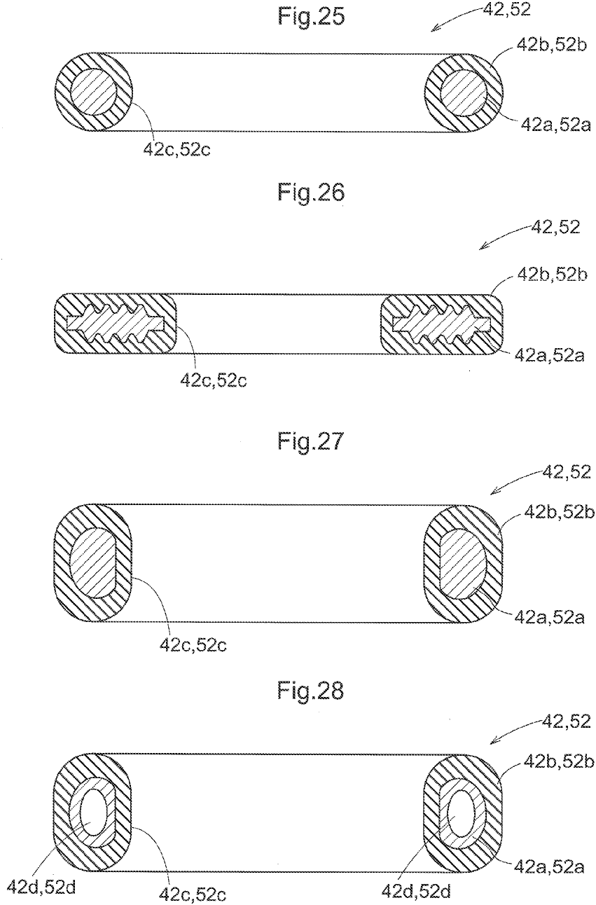

It is preferable that the longitudinal cross-sectional shapes of the metal materials 42a and 52a of the annular packing materials 42 and 52 include one or more of a flat-plate shape (see FIG. 20), a wavelike shape (see FIG. 23), a triangular shape (see FIG. 24), a circular shape (see FIG. 25), an elliptic shape (not illustrated), a saw-blade shape (see FIG. 26), a substantially C-shape (see FIG. 27), and a substantially D-shape (see FIG. 27).

Also, it is preferable that the longitudinal cross-sectional shapes of the metal materials 42a and 52a are ring shapes provided with closed spaces (inner spaces) 42d and 52d thereinside as shown in FIG. 28. That is, the metal materials 42a and 52a are formed in a ring shape over the entire circumference in the longitudinal cross-sectional view, and the closed spaces 42d and 52d separated from the outside are formed in a hermetic manner inside the ring-shaped portion. Note that the closed spaces 42d and 52d are formed in an annular shape over the entire circumference of the metal materials 42a and 52a in the top view.

The closed spaces 42d and 52d are filled with gas or liquid. When the metal materials 42a and 52a are exposed to a high-temperature environment, expansion thereof is further promoted due to thermal expansion of the gas or liquid filling the closed spaces 42d and 52d, and accordingly, the contact pressure can be increased. As a result, much higher sealing ability is exhibited.

Note that, although the longitudinal cross-sectional shapes of the metal materials 42a and 52a shown in FIG. 28 have a substantially D-shape, there is no limitation to this longitudinal cross-sectional shape. For example, a circular shape, an elliptic shape, a triangular shape, a rectangular shape, or the like may be employed.

Examples of constitutional materials of the metal oxide layers 42b and 52b include alumina, silica, magnesium oxide, iron oxide, chromium oxide, and manganese oxide. It is preferable that the metal oxide layers 42b and 52b include at least one selected from the group consisting of alumina, silica, magnesium oxide, iron oxide, chromium oxide, and manganese oxide.

It is sufficient that the metal oxide layers 42b and 52b are provided on at least either the top faces of the metal materials 42a and 52a or the bottom faces thereof when the metal materials 42a and 52a have a flat-plate shape, a wavelike shape, a saw-blade shape, or the like. Also, even when the metal materials 42a and 52a have another shape, the metal oxide layers 42b and 52b need not necessarily be provided so as to cover the entire metal materials 42a and 52a as long as the insulating properties are ensured. The metal oxide layers 42b and 52b may be provided on at least either of the faces in the thickness directions of the metal materials 42a and 52a.

The annular packing materials 42 and 52 according to this embodiment can be produced using a known lamination method through which a metal oxide is layered on the metal materials 42a and 52a. Examples of the method include a method in which an oxide is deposited on the surfaces of the metal materials 42a and 52a by etching the surfaces of the metal materials 42a and 52a and thus the metal oxide layers 42b and 52b are layered thereon, and a method in which a metal oxide is applied, bonded, plated, spray-coated, or thermal-sprayed to the surfaces of the metal materials 42a and 52a and thus the metal oxide layers 42b and 52b are layered thereon. Note that it is preferable to layer the metal oxide layers 42b and 52b on the metal materials 42a and 52a using, for example, low-temperature calcining (not performing calcining treatment in a high temperature range of higher than 1100° C., but rather performing a wet process using calcining treatment in a low temperature range, for example), a spray coating technique (a technique such as a thermal spraying technique, an aerosol deposition technique, an aerosol gas deposition technique, a powder jet deposition technique, a particle jet deposition technique, or a cold spraying technique), a PVD technique (e.g., a sputtering technique or a pulse laser deposition technique), a CVD technique, or the like, because deterioration of the metal materials 42a and 52a can be suppressed.

The temperature of an SOFC significantly differs between when power is generated and when power is not generated, and therefore, the electrochemical element stack S included in an SOFC is in an environment in which the temperature varies and may rise to high temperatures. In this embodiment, as mentioned above, the plate-like members 220 constituted by thermally expandable members are arranged on the top flat face and the bottom flat face of the electrochemical element stack S, and elastically support the electrochemical element stack S due to the upper and lower plates 230 applying predetermined clamping pressure thereto. Furthermore, the annular packing materials 42 and 52 apply contact pressure to the plate-like support 10, and thus the sealing properties are ensured. However, if the temperature repeatedly changes, a small gap may occur between the annular packing materials 42 and 52 and the plate-like support 10 due to, for example, reduced elasticity of the metal oxide layers 42b and 52b.

With the annular packing materials 42 and 52, even when a small gap occurs between the annular packing materials 42 and 52 and the plate-like support 10 due to reduced elasticity of the metal oxide layers 42b and 52b, the contact pressure increases due to expansion tension of the metal materials 42a and 52a while the SOFC generates power, and thus high sealing properties are exhibited. Accordingly, sealing between the inside (i.e., the supply passage 4 and the discharge passage 5) and the outside (i.e., the flowing portion A2) with respect to the metal materials 42a and 52a and the metal oxide layers 42b and 52b is sufficiently ensured between the adjacent plate-like supports 10. Moreover, the metal materials 42a and 52a are not likely to harden even when being exposed to high temperatures, and thus can be used for a long period of time. Furthermore, since the annular packing materials 42 and 52 include the metal oxide layers 42b and 52b, insulation between the adjacent plate-like supports 10 (i.e., between the electrochemical elements A) is also maintained.

In the case where materials are selected such that the thermal expansion rates of the first plate-like body 1 and second plate-like body 2 of the plate-like support 10 are different from the thermal expansion rates of the metal materials 42a and 52a, when they are exposed to high temperatures, thermal expansive force caused by a difference in thermal expansion between the first plate-like body 1 and second plate-like body 2 and the metal materials 42a and 52a can be utilized to increase the contact pressure. As a result, much higher sealing ability is exhibited.

Specifically, the thermal expansion rates of the metal materials 42a and 52a may be larger than the thermal expansion rates of the first plate-like body 1 and the second plate-like body 2, or the thermal expansion rates of the metal materials 42a and 52a may be smaller than the thermal expansion rates of the first plate-like body 1 and the second plate-like body 2. More specifically, the thermal expansion rates of the metal materials 42a and 52a can be made larger than the thermal expansion rates of the first plate-like body 1 and the second plate-like body 2 by using ferrite-based stainless steel for the first plate-like body 1 and the second plate-like body 2 and austenite-based stainless steel for the metal materials 42a and 52a. In this case, when these members are exposed to high temperatures, thermal expansion of the metal materials 42a and 52a is greater than thermal expansion of the first plate-like body 1 and the second plate-like body 2, and thus contact pressure applied to the first plate-like body 1 and the second plate-like body 2 by the metal materials 42a and 52a is increased. As a result, much higher sealing ability is exhibited.

### Energy System, Electrochemical Device

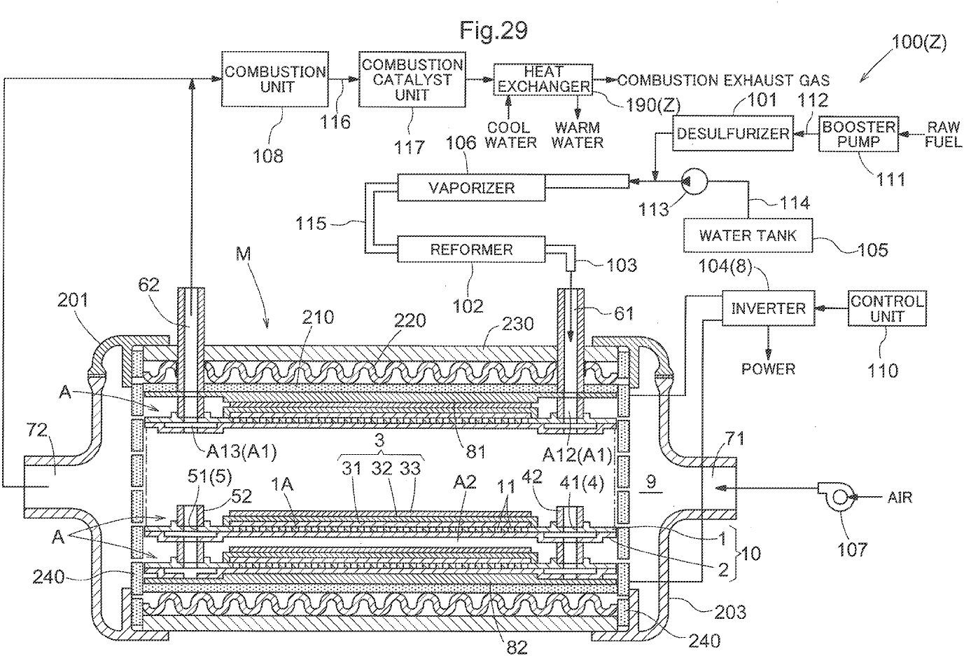

Next, an energy system and an electrochemical device will be described with reference to FIG. 29.

An energy system Z includes an electrochemical device 100, and a heat exchanger 190 serving as a waste heat utilization system that reuses heat discharged from the electrochemical device 100.

The electrochemical device 100 includes the electrochemical module M, a fuel supply module, and an inverter (an example of a power converter) 104 serving as the output portion 8 for extracting power from the electrochemical module M. The fuel supply module includes a fuel supply unit 103 that includes a desulfurizer 101, a vaporizer 106, and a reformer 102, and that supplies fuel gas containing a reducing component to the electrochemical module M. Note that the reformer 102 serves as a fuel converter in this case.

Specifically, the electrochemical device 100 includes the desulfurizer 101, a water tank 105, a vaporizer 106, the reformer 102, a blower 107, a combustion unit 108, the inverter 104, a control unit 110, and the electrochemical module M.

The desulfurizer 101 removes sulfur compound components contained in a hydrocarbon-based raw fuel such as city gas (i.e., performs desulfurization). When a sulfur compound is contained in the raw fuel, the inclusion of the desulfurizer 101 makes it possible to suppress an adverse influence that the sulfur compound has on the reformer 102 or the electrochemical elements A. The vaporizer 106 produces water vapor (steam) from water supplied from the water tank 105. The reformer 102 uses the water vapor (steam) produced by the vaporizer 106 to perform steam reforming of the raw fuel desulfurized by the desulfurizer 101, thus producing reformed gas containing hydrogen.

The electrochemical module M generates power by causing an electrochemical reaction to occur with use of the reformed gas supplied from the reformer 102 and air supplied from the blower 107. The combustion unit 108 mixes the reaction exhaust gas discharged from the electrochemical module M with air, and burns combustible components in the reaction exhaust gas.

The inverter 104 adjusts the power output from the electrochemical module M to obtain the same voltage and frequency as power received from a commercial system (not illustrated). The control unit 110 controls the operation of the electrochemical device 100 and the energy system Z.

The reformer 102 performs reforming process on the raw fuel with use of combustion heat produced by the combustion of reaction exhaust gas in the combustion unit 108.

The raw fuel is supplied to the desulfurizer 101 via a raw fuel supply passage 112, due to operation of a booster pump 111. The water in the water tank 105 is supplied to the vaporizer 106 via a water supply passage 114, due to operation of a water pump 113. The raw fuel supply passage 112 merges with the water supply passage 114 at a location on the downstream side of the desulfurizer 101, and the water and the raw fuel, which have been merged outside of the container 200, are supplied to the vaporizer 106.

The water is vaporized by the vaporizer 106 to produce water vapor. The raw fuel, which contains the water vapor produced by the vaporizer 106, is supplied to the reformer 102 via a water vapor-containing raw fuel supply passage 115. In the reformer 102, the raw fuel is subjected to steam reforming, thus producing reformed gas that contains hydrogen gas as a main component (first gas containing a reducing component). The reformed gas produced in the reformer 102 is supplied to the electrochemical module M via the fuel supply unit 103.

The reaction exhaust gas is burned in the combustion unit 108, and obtained combustion exhaust gas is sent from a combustion exhaust gas discharge passage 116 to the heat exchanger 190. A combustion catalyst unit 117 (e.g., a platinum-based catalyst) is provided in the combustion exhaust gas discharge passage 116, and reducing components such as carbon monoxide and hydrogen contained in the combustion exhaust gas are removed by combustion.

The heat exchanger 190 uses supplied cool water to perform heat exchange on the combustion exhaust gas produced by combustion in the combustion unit 108, thus producing warm water. In other words, the heat exchanger 190 operates as a waste heat utilization system that reuses heat discharged from the electrochemical device 100.

Note that, instead of the waste heat utilization system, it is possible to provide a reaction exhaust gas using unit that uses the reaction exhaust gas that is discharged from (not burned in) the electrochemical module M. At least a portion of the reaction exhaust gas flowing from the first gas discharge portion 62 to the outside of the container 200 may be returned to one of the members 100, 101, 103, 106, 112, 113, and 115 shown in FIG. 29 and recycled. The reaction exhaust gas contains remaining hydrogen gas that was not used in the reaction in the electrochemical elements A. In the reaction exhaust gas using unit, the remaining hydrogen gas is used to perform heat utilization through combustion or power generation by a fuel cell and so on, thus achieving effective energy utilization.

### Modified Examples of Annular Packing Material

Modified examples of the first annular packing material 42 and the second annular packing material 52 will be described. Note that configurations similar to those in the above-described embodiment are denoted by the same reference numeral, and detailed descriptions thereof are omitted.

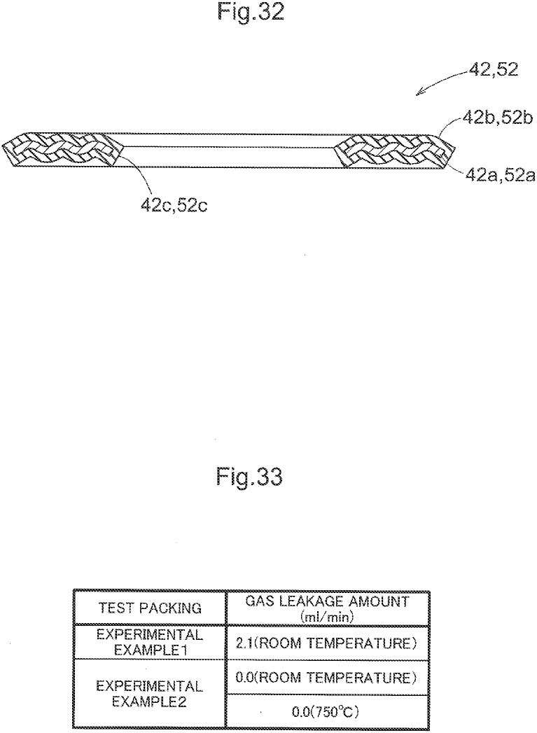

As shown in FIG. 32, in the annular packing materials 42 and 52 of this example, the metal oxide layers 42b and 52b are layered along the surfaces of the metal materials 42a and 52a. In other words, the metal oxide layers 42b and 52b have uniform thicknesses. In the example shown in the diagram, the longitudinal cross-sectional shapes of the metal materials 42a and 52a are wavelike shapes. The cross-sectional shapes (surface shapes) of the metal oxide layers 42b and 52b are also wavelike shapes. In addition, the longitudinal cross-sectional shapes of the annular packing materials 42 and 52 are also wavelike shapes. That is, the longitudinal cross-sectional shapes of the annular packing materials may be the same as the longitudinal cross-sectional shapes of the metal materials 42a and 52a.

In the case where the metal materials 42a and 52a have other cross-sectional shapes (e.g., a triangular shape (see FIG. 24), a saw-blade shape (see FIG. 26), a substantially C-shape (see FIG. 27), or a substantially D-shape (see FIG. 27) as well, the metal oxide layers 42b and 52b may have uniform thicknesses, and the longitudinal cross-sectional shapes of the metal materials 42a and 52a may be the same as the longitudinal cross-sectional shapes of the annular packing materials 42 and 52.

As shown in FIG. 24 and FIGS. 26 to 28, the metal oxide layers 42b and 52b need not have uniform thicknesses. The longitudinal cross-sectional shapes of the annular packing materials may be different from the longitudinal cross-sectional shapes of the metal materials 42a and 52a.

### Modified Examples of Electrochemical Element Stack and Electrochemical Module

The electrochemical element stack S and the electrochemical module M may have a configuration in which a ceramic paste is applied to at least a part of a surface of the first annular packing material 42 and the second annular packing material 52, the ceramic paste being arranged between the plate-like support 10 (an example of a metal substrate) and the annular packing materials 42 and 52. The ceramic paste may be applied to the entire surfaces of the annular packing materials 42 and 52. The ceramic paste may be applied to only the faces on the front side or the faces on the back side of the annular packing materials 42 and 52.

The ceramic paste enhances the gas-tightness (sealing) of a connection portion, and an example thereof is a gasket paste. The ceramic paste contains ceramics as a main component, and is made into a paste form using a thickener. The main component of the ceramic paste may be a metal oxide or inorganic polymer. The main component of the ceramic paste may be mica, silica, or alumina. The ceramic paste may be soluble in water.

In the electrochemical module M, the electrochemical elements A need not be stacked. In other words, in the electrochemical module M, a plurality of electrochemical elements A are arranged in an assembled state. In the electrochemical element stack S, the electrochemical elements A need not be stacked. In other words, in the electrochemical element stack S, a plurality of electrochemical elements A are arranged in an assembled state. In this case, the electrochemical element stack S may also be referred to as an “electrochemical element assembly”.

### Results of Gas Leakage Amount Measurement Test

Results of a gas leakage amount measurement test performed using the above-described annular packing materials 42 and 52 and ceramic paste will be described with reference to a table shown in FIG. 33.

A closed container with a capacity of 1 liter provided with one opening was produced. The opening was sealed using a test packing material. Nitrogen was supplied to the closed container to increase the internal pressure. When the internal pressure reached test pressure, nitrogen supply was stopped, and the pressure was measured 10 minutes later. A gas leakage amount was calculated from a difference between the test pressure and the measured pressure. The test was carried out at room temperature and 750° C. (only for Experimental Example 2). The test pressure was about 23 kPa, which is about 10 times as high as the normal service pressure for the electrochemical element stack S and the electrochemical module M.

The following two types of packings were used as the test packings.

### Experimental Example 1

A commercially available vermiculite-glass-based composite packing was used as a test packing of Experimental Example 1.

### Experimental Example 2

The annular packing material shown in FIG. 32 to which a ceramic paste containing mica as a main component had been applied was used as a test packing of Experimental Example 2. The metal material of the annular packing material was a ring-shaped stainless corrugated plate made of SUS430. The metal material had a thickness of 0.1 mm. The metal oxide layer of the annular packing material was made of alumina. The metal oxide layer had a thickness of 1 µm to 2 µm. The metal oxide layer was layered on the surface of the metal material using a spray coating technique.

FIG. 33 shows the results of the gas leakage amount measurement test. When the test packing of Experimental Example 1 was used at room temperature, the gas leakage amount was 2.1 ml/min. In contrast, when the test packing of Experimental Example 2 was used, the gas leakage amount was 0.0 ml/min, which was smaller than or equal to the measurement limit. When the test packing of Experimental Example 2 was used at 750° C., the gas leakage amount was 0.0 ml/min, which was smaller than or equal to the measurement limit. Since the gas leakage amount was large at room temperature, the test for the test packing of Experimental Example 1 was not carried out at 750° C.

It was confirmed from the experimental results that using the test packing of Experimental Example 2 made it possible to considerably reduce the gas leakage amount both at room temperature and at a high temperature of 750° C. Note that the test packing of Experimental Example 2 corresponds to a working example of the present invention. The test packing of Experimental Example 1 corresponds to a comparative example of the present invention.

### Other Embodiments

The configuration disclosed in the embodiment described above (including the other embodiments; the same applies to the following) can be applied in combination with configurations disclosed in the other embodiments as long as no contradiction arises. Also, the embodiments disclosed in this specification are illustrative, embodiments of the present invention are not limited to the disclosed embodiments, and appropriate modifications can be made without departing from the object of the present invention.

(1) In the embodiment above, the plate-like members 220 are applied to the electrochemical module M in which the electrochemical elements A are SOFCs. However, the above-mentioned plate-like members 220 can also be applied to SOECs (Solid Oxide Electrolyzer Cells), secondary cells, and the like.

(2) Although the electrochemical elements A are used in a solid oxide fuel cell serving as the electrochemical device 100 in the embodiment above, the electrochemical elements A can also be used in a solid oxide electrolysis cell, an oxygen sensor using a solid oxide, and the like. The electrochemical elements A can also be used alone as well as used in combination of two or more for the electrochemical element stack S or the electrochemical module M.

That is, in the embodiment above, a configuration that can improve the efficiency of converting chemical energy such as fuel into electric energy is described. In other words, in the embodiment above, the electrochemical elements A and the electrochemical module M are operated as fuel cells, and hydrogen gas flows to the electrode layer 31 and oxygen gas flows to the counter electrode layer 33. Accordingly, oxygen molecules O₂ react with electrons e⁻ to produce oxygen ions O²⁻ in the counter electrode layer 33. The oxygen ions O²⁻ move through the electrolyte layer 32 to the electrode layer 31. In the electrode layer 31, hydrogen molecules H₂ react with oxygen ions O²⁻ to produce water H₂O and electrons e⁻. With these reactions, an electromotive force is generated between the electrode layer 31 and the counter electrode layer 33, and power is generated.

On the other hand, when the electrochemical elements A and the electrochemical module M are operated as electrolysis cells, gas containing water vapor and carbon dioxide flows to the electrode layer 31, and a voltage is supplied between the electrode layer 31 and the counter electrode layer 33. As a result, in the electrode layer 31, electrons e⁻ react with water molecules H₂O and carbon dioxide molecules CO₂ to produce hydrogen molecules H₂, and carbon monoxide CO and oxygen ions O²⁻. The oxygen ions O²⁻ move to the counter electrode layer 33 through the electrolyte layer 32. In the counter electrode layer 33, the oxygen ions O²⁻ release electrons and oxygen molecules O₂ are produced. Through the reactions above, water molecules H₂O are electrolyzed into hydrogen H₂ and oxygen O₂, and in the case where gas containing carbon dioxide molecules CO₂ flows, carbon dioxide molecules CO₂ are electrolyzed into carbon monoxide CO and oxygen O₂.

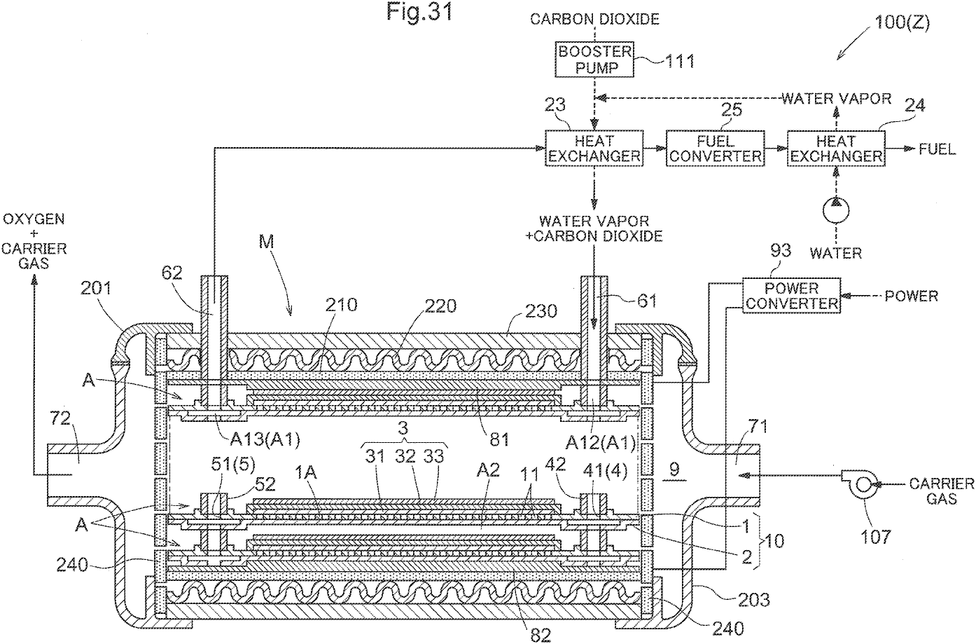

In the case where gas containing water vapor and carbon dioxide molecules CO₂ flows, a fuel converter 25 (FIG. 31) that synthesizes various compounds such as hydrocarbons from hydrogen, carbon monoxide, and the like generated through the above-mentioned electrolysis in the electrochemical elements A and the electrochemical module M can be provided. With the fuel supply unit (not illustrated), hydrocarbon and the like produced by this fuel converter 25 can be extracted from the system and the device and separately used as fuel or the like. Moreover, a configuration is also possible in which hydrogen or carbon monoxide is converted into chemical raw material in the fuel converter 25 and then the resulting chemical raw material is used.

FIG. 31 shows examples of the energy system Z and the electrochemical device 100 in the case where the electrochemical reaction portions 3 are operated as electrolysis cells (an electrolysis reaction is caused in the electrochemical elements A). In this system, supplied water and carbon dioxide are electrolyzed in the electrochemical reaction portion 3 to produce hydrogen, carbon monoxide, and the like. Furthermore, in the fuel converter 25, hydrocarbons and the like are synthesized. By employing the configuration in which the heat exchanger 24 shown in FIG. 31 is operated as a waste heat utilization system that performs heat exchange between the water and the reaction heat produced by the reaction in the fuel converter 25 to vaporize the water, and the heat exchanger 23 shown in FIG. 31 is operated as a waste heat utilization system that performs heat exchange between water vapor and carbon dioxide, and waste heat produced by the electrochemical elements A to preheat the water vapor and the carbon dioxide, the energy efficiency can be improved. Moreover, a power converter 93 supplies power to the electrochemical elements A. Accordingly, as mentioned above, the electrochemical elements A function as electrolysis cells. Therefore, with the above-mentioned configuration, an electrochemical device 100, an energy system Z, and the like that can improve the efficiency of converting electric energy into chemical energy such as fuel can be provided.

(3) In the embodiment above, a composite material such as NiO—GDC, Ni—GDC, NiO—YSZ, Ni—YSZ, CuO—CeO₂, or Cu—CeO₂ is used as the material of the electrode layer 31, and a complex oxide such as LSCF or LSM is used as the material of the counter electrode layer 33. With this configuration, the electrode layer 31 serves as a fuel electrode (anode) when hydrogen gas is supplied thereto, and the counter electrode layer 33 serves as an air electrode (cathode) when air is supplied thereto, thus making it possible to use the electrochemical element A as a cell for a solid oxide fuel cell. It is also possible to change this configuration and thus configure an electrochemical element A such that the electrode layer 31 can be used as an air electrode and the counter electrode layer 33 can be used as a fuel electrode. That is, a complex oxide such as LSCF or LSM is used as the material of the electrode layer 31, and a composite material such as NiO—GDC, Ni—GDC, NiO—YSZ, Ni—YSZ, CuO—CeO₂, or Cu—CeO₂ is used as the material of the counter electrode layer 33. With this configuration, the electrode layer 31 serves as an air electrode when air is supplied thereto, and the counter electrode layer 33 serves as a fuel electrode when hydrogen gas is supplied thereto, thus making it possible to use the electrochemical element A as a cell for a solid oxide fuel cell.

(4) In the embodiment above, the electrode layer 31 is arranged between the first plate-like body 1 and the electrolyte layer 32, and the counter electrode layer 33 is arranged on the side of the electrolyte layer 32 opposite to the first plate-like body 1. A configuration is also possible in which the electrode layer 31 and the counter electrode layer 33 are provided in an inversed arrangement. Specifically, a configuration is also possible in which the counter electrode layer 33 is arranged between the first plate-like body 1 and the electrolyte layer 32, and the electrode layer 31 is arranged on the side of the electrolyte layer 32 opposite to the first plate-like body 1. In this case, a change also needs to be made regarding the supply of gas to the electrochemical elements A.

That is, regarding the order of the electrode layer 31 and the counter electrode layer 33, and which is employed a configuration in which the first gas is reducing component gas and the second gas is oxidative component gas or a configuration in which the first gas is oxidative component gas and the second gas is reducing component gas, various aspects can be employed as long as the electrode layer 31 and the counter electrode layer 33 are arranged such that the first gas and the second gas are supplied thereto so as to appropriately react with each other.

(5) Although the electrochemical reaction portion 3 covering the gas-permeable portion 1A is provided on a side of the first plate-like body 1 opposite to the second plate-like body 2 in the embodiment above, the electrochemical reaction portion 3 may also be provided on the second plate-like body 2 side of the first plate-like body 1. That is, the present invention can be achieved even when a configuration is employed in which the electrochemical reaction portion 3 is arranged in the internal passage A1.

(6) Although the first penetrated portion 41 and the second penetrated portion 51 are provided as a pair at the two end portions of the rectangular plate-like support in the embodiment above, there is no limitation to the configuration in which they are provided at the two end portions. A configuration may also be employed in which two or more pairs are provided. The first penetrated portion 41 and the second penetrated portion 51 need not be provided as a pair. Accordingly, one or more first penetrated portions 41 and one or more second penetrated portions 51 can be provided. Furthermore, the shape of the plate-like support is not limited to a rectangular shape, and various shapes such as a square shape and a circular shape can be employed.

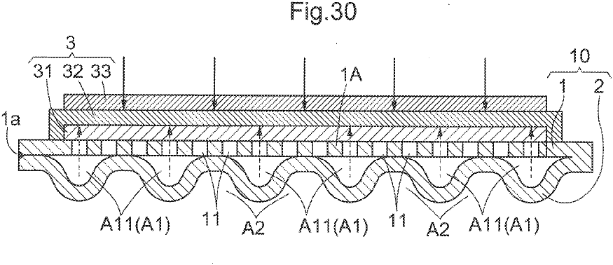

(7) In the description above, the plate-like support 10 includes the first plate-like body 1 and the second plate-like body 2. Separate plate-like bodies may be used to form the first plate-like body 1 and the second plate-like body 2, or a single plate-like body as shown in FIG. 30 may be used to form the first plate-like body 1 and the second plate-like body 2. In the case shown in FIG. 30, the first plate-like body 1 and the second plate-like body 2 are stacked by folding a single plate-like body. The first plate-like body 1 and the second plate-like body 2 are integrated by, for example, welding the peripheral portions 1a. Note that a continuous seamless plate-like body may be used to form the first plate-like body 1 and the second plate-like body 2 and may be folded to be shaped as shown in FIG. 30.

Moreover, as described later, the second plate-like body 2 may be constituted by a single member or two or more members. Similarly, the first plate-like body 1 may be constituted by a single member or two or more members.

(8) The above-mentioned second plate-like body 2 forms the internal passage A1 together with the first plate-like body 1. The internal passage A1 includes the distribution portion A12, a plurality of auxiliary passages A11, and the confluence portion A13. As shown in FIG. 9, the first gas supplied to the distribution portion A12 is distributed and supplied to the plurality of auxiliary passages A11, and merges in the confluence portion A13 after leaving the auxiliary passages A11 through the exits. Accordingly, the first gas flows in a gas-flowing direction from the distribution portion A12 toward the confluence portion A13. The plurality of auxiliary passages A11 is formed by shaping the portion of the second-plate like body 2 other than the portions corresponding to the distribution portion A12 and the confluence portion A13 into a wavelike shape. As shown in FIG. 13, the plurality of auxiliary passages A11 form a wavelike shape in a cross-sectional view taken in a flow-intersection direction that intersects the direction in which the first gas flows. The plurality of auxiliary passages A11 are formed by extending the wavelike plate in the gas flowing direction shown in FIG. 9. The plurality of auxiliary passages A11 may be formed of a continuous wavelike plate-like body or two or more wavelike plate-like bodies between the distribution portion A12 and the confluence portion A13. For example, the plurality of auxiliary passages A11 may be formed of two or more wavelike plate-like bodies that are separate from each other in a direction extending in the gas flowing direction, or two or more wavelike plate-like bodies that are separate from each other in a direction extending in the flow-intersection direction.

As shown in FIG. 13, the plurality of auxiliary passages A11 form a wavelike shape by repeatedly forming crests and troughs with the same shape. However, the second plate-like body 2 may include a plate-like portion in the region provided with the plurality of auxiliary passages A11. For example, the plurality of auxiliary passages A11 may be formed by forming plate-like portions and protruding portions alternately. The protruding portions can be used as portions in which a fluid such as the first gas flows.

(9) The portion of the above-mentioned second plate-like body 2 corresponding to the plurality of auxiliary passages A11 need not be formed in a wavelike shape as a whole, and it is sufficient that at least a portion thereof is formed in a wavelike shape. For example, the second plate-like body 2 may be formed such that a portion in the gas flowing direction has a flat shape and the portion other than the flat portion has a wavelike shape, between the distribution portion A12 and the confluence portion A13. The second plate-like body 2 may also be formed such that a portion in the flow-intersection direction has a flat shape and the portion other than the flat portion has a wavelike shape.

(10) In the embodiment above, the electrochemical device includes the electrochemical module M that includes the plurality of electrochemical elements A. However, a configuration in which a single electrochemical element is included can be applied to the electrochemical device of the embodiment above.

The configuration disclosed in the embodiment described above can be applied in combination with configurations disclosed in the other embodiments as long as no contradiction arises. Also, the embodiments disclosed in this specification are illustrative, embodiments of the present invention are not limited to the disclosed embodiments, and appropriate modifications can be made without departing from the object of the present invention.

### INDUSTRIAL APPLICABILITY

The present invention can be favorably used in technical fields related to an annular packing material, an electrochemical module, an electrochemical device, an energy system, a solid oxide fuel cell, and a solid oxide electrolysis cell.

### DESCRIPTION OF REFERENCE SIGNS

25: Fuel converter
31: Electrode layer
32: Electrolyte layer
33: Counter electrode layer
42: First annular packing material
52: Second annular packing material
42a, 52a: Metal material
420a, 520a: Bimetal
421a, 521a: Metal with small thermal expansion coefficient
422a, 522a: Metal with large thermal expansion coefficient
42b, 52b: Metal oxide layer
42c, 52c: Through hole
42d, 52d: Closed space
93: Power converter
100: Electrochemical device
101: Desulfurizer
102: Reformer
103: Fuel supply unit
104: Inverter
200: Container
220: Plate-like member
230: Plate
A: Electrochemical element
M: Electrochemical module
S: Electrochemical element stack
Z: Energy system

1. An annular packing material comprising:
a metal material made of a thermally expandable member that thermally expands; and
an insulating metal oxide layer,
wherein the metal material and the metal oxide layer formed in an annular shape have a through hole thereinside.

2. The annular packing material according to claim 1,
wherein the metal oxide layer is arranged on at least one side in a thickness direction of the metal material.

3. The annular packing material according to claim 1,
wherein the metal oxide layer includes one or more of alumina, silica, magnesium oxide, iron oxide, chromium oxide, and manganese oxide.

4. The annular packing material according to claim 1,
wherein the metal material includes one or more of ferrite-based stainless steel, austenite-based stainless steel, Inconel, copper, and an invar material.

5. The annular packing material according to claim 1,
wherein the metal material has a cross-sectional shape that is a ring shape provided with a closed space thereinside.

6. The annular packing material according to claim 1,
wherein the metal material is made of a bimetal.

7. The annular packing material according to claim 1,
wherein the metal material has a cross-sectional shape that includes one or more of a flat-plate shape, a triangular shape, a saw-blade shape, a wavelike shape, a circular shape, an elliptic shape, a substantially C-shape, and a substantially D-shape.

8. An electrochemical module comprising:
a plurality of electrochemical elements that each comprise:
an electrolyte layer; and
a first electrode and a second electrode that are respectively arranged on two sides of the electrolyte layer,
wherein the electrochemical elements are stacked with metal wherein substrates provided therebetween, and
wherein the annular packing material according to claim 1 is arranged between adjacent metal substrates.

9. The electrochemical module according to claim 8,
wherein the metal material has a thermal expansion coefficient that is different from a thermal expansion coefficient of the metal substrate.

10. The electrochemical module according to claim 8,
wherein a ceramic paste is applied to at least a part of a surface of the annular packing material, and the ceramic paste is arranged between the metal substrate and the annular packing material.

11. The electrochemical module according to claim 10,
wherein the ceramic paste contains mica.

12. An electrochemical device comprising:
the electrochemical module according to 8; and
a fuel converter that generates a reducing component to be supplied to the electrochemical module or converts gas containing a reducing component generated in the electrochemical module.

13. An electrochemical device comprising:
the electrochemical module according to claim 8; and
a power converter that extracts power from the electrochemical module, or supplies power to the electrochemical module.

14. An energy system comprising:
the electrochemical device according to claim 12; and
a waste heat utilization system that reuses heat discharged from the electrochemical device.

15. A solid oxide fuel cell comprising
and the electrochemical module according to claim 8,
wherein the electrochemical module causes a power generating reaction.

16. A solid oxide electrolysis cell comprising
the electrochemical module according to claim 8,
wherein the electrochemical module causes an electrolysis reaction.
